(19) United States
(12) Patent Application Publication
(10) Pub. No.: US 2025/0348753 A1
(43) Pub. Date: Nov. 13, 2025

(54) TEXT-TO-VISION GENERATION WITH PROMPT MODIFICATION AND SCORING

(71) Applicant: GDM Holding LLC, Mountain View, CA (US)

(72) Inventors: Yu Qing Du, London (GB); Benigno Uria-Martínez, London (GB); Aaron Gerard Antonius van den Oord, London (GB); Christos Kaplanis, London (GB); Hansa Srinivasan, Brooklyn, NY (US); Jason Michael Baldridge, Austin, TX (US); Srivatsan Srinivasan, London (GB); Zachary Frank Eaton-Rosen, London (GB); Ksenia Konyushkova, London (GB); Charlie Thomas Curtis Nash, London (GB); Conor Michael Durkan, New York, NY (US); Jeffrey Donahue, London (GB); Evgeny Gladchenko, London (GB); Pauline Luc, London (GB); Hyun Jik Kim, London (GB); Mohammad Babaeizadeh, San Jose, CA (US); Medhini Gulganjalli Narasimhan, Palo Alto, CA (US); Poorva Ganesh Rane, Sunnyvale, CA (US)

(21) Appl. No.: 19/207,229

(22) Filed: May 13, 2025

Related U.S. Application Data
(60) Provisional application No. 63/646,691, filed on May 13, 2024.
(60) Provisional application No. 63/703,822, filed on Oct. 4, 2024.

(51) Int. Cl. G06N 3/096; G06N 3/0475

(52) U.S. Cl. CPC G06N 3/096; G06N 3/0475

(57) ABSTRACT

There is provided a method performed by one or more data processing apparatus. The method comprises obtaining a training prompt and a corresponding target modified prompt from a training dataset. The training dataset comprises one or more training prompt and target modified prompt pairs generated using a first generative machine learning model. The method further comprises processing, by a second generative machine learning model, the training prompt to generate an output modified prompt. The second generative machine learning model has a lower parameter count than the first generative machine learning model. The method further comprises updating the second generative machine learning model using a training objective based upon the output modified prompt and the target modified prompt.

### CROSS-REFERENCE TO RELATED APPLICATIONS

This application claims priority to U.S. Provisional Application No. 63/646,691, filed on May 13, 2024, and U.S. Provisional Application No. 63/703,822, filed on Oct. 4, 2024. The disclosures of the prior applications are considered part of and are incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

According to a first aspect, there is provided a method performed by one or more data processing apparatus. The method comprises obtaining a training prompt and a corresponding target modified prompt from a training dataset. The training dataset comprises one or more training prompt and target modified prompt pairs generated using a first generative machine learning model. The method further comprises processing, by a second generative machine learning model, the training prompt to generate an output modified prompt. The second generative machine learning model has a lower parameter count than the first generative machine learning model. The method further comprises updating the second generative machine learning model using a training objective based upon the output modified prompt and the target modified prompt.

In some implementations, the parameter count of the second generative machine learning model is less than half of the parameter count of the first generative machine learning model. In some implementations, the parameter count of the second generative machine learning model is less than 25% of the parameter count of the first generative machine learning model. In some implementations, the parameter count of the second generative machine learning model is less than 10% of the parameter count of the first generative machine learning model. In some implementations, the parameter count of the second generative machine learning model is less than 5% of the parameter count of the first generative machine learning model.

In some implementations, the method further comprises generating the training dataset. Generating the training dataset can comprise obtaining one or more user prompts and for each of the one or more user prompts, generating, using the first generative machine learning model, one or more modified user prompts to generate one or more candidate training pairs. The candidate training pairs can be added to the training dataset. In some implementations, one modified user prompt is generated for each initial user prompt. In other implementations, N modified user prompts are generated for each initial user prompt.

In some implementations, the candidate pairs are filtered based upon determining whether the modified user prompt entails the original user prompt using a natural language understanding technique prior to adding the candidate pairs to the training dataset. In general, given a pair of text fragments, a premise P and hypothesis H, entailment means that H is necessarily true or appropriate when P is true. For example, the premise could be “I have a cat” and the hypothesis could be “I have a pet”. Thus, P entails H. A contradiction means H is necessarily false or inappropriate whenever P is true. For example, the premise could be “The cat sat on the mat” and the hypothesis could be “The cat did not sit on the mat”. Thus, P does not entail H, P contradicts H. In addition, there can also be a third class where P and H are unrelated. For example, the premise could be “I saw a cat” and the hypothesis could be “I wrote my essay”. Thus, neither P entails H or P contradicts H. In some instances, this task is referred to as “textual entailment” or “natural language inference”. Further details can be found in Parikh, A. P., Täckström, O., Das, D. and Uszkoreit, J., A decomposable attention model for natural language inference, arXiv preprint arXiv: 1606.01933, 2016, which is hereby incorporated by reference in its entirety.

In some implementations, human feedback is obtained with respect to the generated candidate pairs and the candidate pairs are filtered based upon the obtained human feedback prior to adding the candidate training pairs to the training dataset. For example, human reviewers can be shown the original user prompt and the modified user prompt and asked to consider whether the modified user prompt entails the original user prompt and/or whether the modified user prompt does not introduce any inconsistencies.

In some implementations, the training dataset comprises a (first) portion of the training data that is generated by the first generative machine learning model that has not been filtered using human feedback. In some implementations, the training dataset comprises a (second) portion of the training data that is generated by the first generative machine learning model that has been filtered using human feedback. In some implementations, the training dataset comprises a (third) portion of the training data that comprises pairs of human generated captions and synthetically generated captions for a plurality of sets of visual data (e.g., images or videos) obtained from a further training dataset for training a text-to-vision generation system. The text-to-vision generation system can be the text-to-vision generation system that the second generative machine learning model will be used in conjunction with when training of the second generative machine learning model has been completed.

It will be appreciated that the training dataset can include any combination of the first, second and third portions. It will also be appreciated that the training dataset can include further data outside of the first, second and third portions.

In some implementations, each portion of the training dataset is associated with a sampling weight. For example, the second portion (the human filtered portion) can have the largest sampling weight as this portion can include the most reliable data. In another example, the third portion (the text-to-vision generation system training data) has the lowest sampling weight as this portion can be much larger in size and can also be the data with the most noise. The sampling weights can also be determined based upon the size of each portion of the training dataset.

In some implementations, obtaining the training prompt and corresponding target modified prompt from the training dataset comprises sampling a training pair from the training dataset based upon the sampling weight for each portion.

In some implementations, the output of the first generative machine learning model is constrained based upon a finite state transducer. For example, the finite state transducer can ensure the first generative machine learning model provides an output that conforms to a particular format, e.g., JSON. In another example, the finite state transducer can ensure that the first generative machine learning model provides a specified number of modified prompts per input prompt.

In some implementations, the training prompt is modified to have increased similarity to prompts used to train a text-to-vision generation system. For example, the text-to-vision generation system may have been trained using longer and more descriptive synthetic captions. The training prompt can be modified to include more details, for example, by adding more specific characteristics to objects mentioned in the training prompt. For example, if a car is mentioned in the training prompt, further characteristics such as the color of the car and the size of the car can be added. In another example, specific terms from a particular related domain can be included.

In some implementations, the first generative machine learning model and the second generative machine learning model are large language model (LLM) based machine learning models (e.g., foundation models). This can also include multi-modal models that are capable of processing text input together with other modalities such as image, video and/or audio.

In some implementations, the second machine learning model is pre-trained. For example, the second machine learning model can be a pre-trained LLM. In some implementations, updating the second generative machine learning model is based upon a parameter efficient fine-tuning technique (PEFT). For example, the parameter efficient fine-tuning technique can be based upon a low rank adaptation (LoRA) technique.

In some implementations, the first generative machine learning model is based upon a Mixture of Experts architecture and/or comprises one or more sparsity-based layers. In some implementations, the second generative machine learning model is a dense model. In some implementations, the first and/or second generative machine learning models comprise one or more artificial neural network models. In some implementations, the first and/or second generative machine learning models comprise one or more neural network layers.

According to a second aspect, there is provided a method performed by one or more data processing apparatus. The method comprises obtaining a user prompt comprising instructions for generating visual data (e.g., an image or video) using a text-to-vision generation system (e.g., a text-to-image generation model or a text-to-video generation model). The method further comprises processing, using a distilled generative machine learning model, the user prompt to generate a modified prompt. The distilled generative machine learning model has been trained using a dataset generated by a reference generative machine learning model having a larger parameter count than the distilled generative machine learning model. The method further comprises generating, using the text-to-vision generation system, visual data based upon the modified prompt.

In some implementations, the distilled generative machine learning model is trained according to the first aspect described above with the distilled generative machine learning model corresponding to the second generative machine learning model and the reference generative machine learning model corresponding to the first generative machine learning model. Further details regarding training distilled models can be found in, Hinton, G., Vinyals, O. and Dean, J., Distilling the knowledge in a neural network, arXiv preprint arXiv: 1503.02531, 2015, which is hereby incorporated by reference in its entirety.

In a third aspect, there is provided a method performed by one or more data processing apparatus. The method comprises obtaining visual data (e.g., an image or video) and a corresponding text description, wherein the visual data is an image or video. The method further comprises processing, using a vision scoring machine learning model (e.g., an image scoring machine-learning model or a video scoring machine-learning model or more generally a visual data scoring machine-learning model), the visual data to generate a target vision score (e.g., a target image score or a target video score or more generally a visual data score). The method further comprises processing, using a prompt scoring machine learning model, the text description to generate an inferred vision score (e.g., an inferred image score or am inferred video score or more generally a visual data score) for the text description. The method further comprises updating the prompt scoring model using a training objective based upon the inferred vision score and the target vision score.

That is, the prompt scoring machine learning model does not see the image/video and must infer the vision score from the prompt alone whilst the vision scoring model does not see the prompt and scores the image/video based upon the image/video only.

In some implementations, the vision score is a continuous valued number. In some implementations, the vision score is in the range 0 to 10 inclusive. Alternatively, the vision score is in the range 0 to 1 inclusive.

In some implementations, the target and inferred vision scores are based upon a ranking of the visual data, e.g., an image ranking or a video ranking. The visual data ranking can be an ordering over sets of visual data (e.g., an ordering of images or video). The ordering can be based upon an attribute of the visual data. The visual data ranking can therefore provide an indication of the type of an image/video and can be used as an additional conditioning signal in text-to-vision generation.

In some implementations, the vision scoring machine learning model is trained based upon scoring data generated from human image/video preference data. For example, human reviewers can be shown a pair of images or videos and asked which of the two images they prefer in order to generate the preference data.

In some implementations, the method further comprises obtaining a training dataset comprising a plurality of visual data and text description pairs, clustering the visual data, and determining candidate pairs of visual data for generating human preference data by sampling pairs of visual data within a cluster. This can ensure that when a human reviewer is shown a pair of images or videos, these images/videos are in some way semantically related and the comparison is a meaningful comparison.

In some implementations, the visual data is clustered by generating an embedding for each set of visual data (e.g., generating an embedding for each image or video) and clustering the visual data based upon the embeddings of each set of visual data. For example, the embedding of the visual data can be based upon a contrastive embedding technique such as CLIP.

In some implementations, processing, using a vision scoring machine learning model, the visual data to generate a target vision score comprises generating an embedding of the visual data and processing the embedding of the visual data using the vision scoring machine learning model to generate the target vision score. The same embedding technique can be used as above.

In some implementations, where the visual data is a video, generating the embedding of the visual data can comprise: generating a subset of frames of the video, comprising sampling every N-th frame of video, wherein N>1; and processing the subset of frames of the video using an embedding model to generate the embedding of the visual data. In some implementations, the embedding model comprises a contrastive embedding model.

In some implementations, processing, using a prompt scoring machine learning model, the text description to generate an inferred vision score comprises generating an embedding of the text description and processing the embedding of the text description using the prompt scoring machine learning model to generate the inferred vision score. Any suitable text embedding/encoding technique can be used.

In some implementations, the vision scoring machine learning model comprises a feedforward neural network. In some implementations, the feedback neural network comprises a single hidden layer. For example, the feedforward neural network can be an MLP with a single hidden layer. In some implementations, the feedforward neural network comprises two hidden layers. For example, the feedforward neural network can be an MLP with two hidden layers.

In some implementations, the prompt scoring machine learning model comprises one or more Transformer-based neural network blocks. The prompt scoring machine learning model can have an encoder/decoder, encoder-only or decoder-only architecture.

In some implementations, the vision scoring machine learning model is trained using a training objective based upon a Bradley-Terry model.

In some implementations, the prompt scoring machine learning model is updated using a regression-based training objective.

According to a fourth aspect, there is provided a method performed by one or more data processing apparatus. The method comprises obtaining a user prompt comprising instructions for generating visual data (e.g., an image or video) using a text-to-vision generation system. The method further comprises processing, using a prompt scoring machine learning model, the user prompt to generate an inferred vision score (e.g., an inferred image score or inferred video score). The method further comprises generating, using the text-to-vision generation system, a set of visual data based upon the user prompt and the inferred vision score.

In some implementations, a range of vision scores is determined from the inferred vision score and the visual data is generated based upon the range of vision scores. For example, the inferred vision score can be a lower bound and the range of vision scores can range from the inferred vision score to the highest possible vision score.

In some implementations, the prompt scoring machine learning model is trained using a method according to the third aspect.

According to a fifth aspect, there is provided a method performed by one or more data processing apparatus. The method comprises obtaining a dataset comprising a plurality of text description and visual data training pairs for training a text-to-vision generation system and filtering the dataset. Filtering the dataset comprises processing, using a vision scoring machine learning model, visual data of a training pair to generate a vision score; processing, using a prompt scoring machine learning model, the corresponding text description of the training pair to generate an inferred vision score; and determining whether to remove or keep the training pair in the dataset based upon a comparison between the vision score and the inferred vision score.

In some implementations, the filtered dataset can then be used to train a text-to-vision generation system.

It will be appreciated that removing a training pair from the dataset may not require physical deletion. For example, a flag can be set to mark the training pair as not to be used.

In some implementations, the prompt scoring machine learning model and/or the vision scoring machine learning model are trained using a method according to the third aspect.

According to a sixth aspect, there is provided a method performed by one or more data processing apparatus. The method comprises receiving a prompt comprising instructions for generating a set of visual data. The method further comprises modifying the prompt using the distilled generative machine learning model of the second aspect. The method further comprises generating an image based on the modified prompt using a text-to-vision generation system trained using a training dataset filtered according to the fifth aspect.

According to a seventh aspect, there is provided a method performed by one or more data processing apparatus. The method comprises receiving a prompt comprising instructions for generating a set of visual data. The method further comprises modifying the prompt using the distilled generative machine learning model of the second aspect. The method further comprises processing the prompt or the modified prompt using the prompt scoring machine learning model of the third or fourth aspects and generating a set of visual data based on the modified prompt and the inferred vision score using a text-to-vision generation system.

According to an eighth aspect, there is provided a method for determining quality scores of input videos. The method is performed by one or more data processing apparatus. The method comprises: obtaining a user prompt comprising instructions for generating video using a text-to-vision generation system; obtaining a target video quality score; and processing, using the text-to-vision generation system, the user prompt and the target video quality score to generate an output video, wherein the quality of the output video corresponds to the target video quality score.

In some implementations, the target video quality score is a numerical value between zero and one. The numerical score can take continuous values.

In some implementations, the text-to-video generation system comprises a latent diffusion model.

According to a ninth aspect, there is provided a method for generating a quality score for a video. The method is performed by one or more data processing apparatus. The method comprises: obtaining a video; processing the video using a video embedding model to generate an embedding of the video; processing the embedding of the video using a video scoring machine learning model to generate a video quality score for the video. The video quality score can be used for one or more downstream tasks. For example, the video quality score can be used to determine whether to include a video in a training dataset. The quality score can be used as a data filtering signal and/or a diffusion model conditioning signal.

In some implementations, the video quality score is a numerical value between zero and one. The numerical score may take continuous values.

In some implementations, processing the video using a video embedding model to generate an embedding of the video comprises: generating a subset of frames of the video, comprising sampling N frames of video, wherein N>1; and processing the subset of frames of the video using a video embedding model to generate an embedding of the video. In some examples, N corresponds to a predefined framerate, e.g., 1 frame per second. In some examples, N corresponds to a fixed predefined number, e.g., N frames of the video are taken, irrespective of the video length.

In some implementations, the video embedding model is a contrastive embedding model. Examples of such models include the ALIGN model and/or CLIP models.

In some examples, processing the subset of frames of the video using a video embedding model to generate an embedding of the video comprises processing each frame of the subset of frames of the video using the video embedding model to generate a respective frame embedding for each frame of the subset of frames. The respective frame embeddings can then be concatenated to generate the embedding of the video.

In some implementations, the video scoring machine learning model comprises a feedforward neural network. The feedforward neural network can, for example, comprise two hidden layers.

In some implementations, the method further comprises: comparing the video quality score for the video to a threshold video score; in response to determining that the video quality score is above the threshold video score, including the video in a training dataset comprising a plurality of videos; and in response to determining that the video quality score is not above the threshold video score, refraining from including the video in the training dataset. The threshold quality score is, in some examples where the score is constrained to be between zero and one, at least 0.5, e.g., at least 0.6, for example 0.7.

The training dataset can then be used to train a video processing model and/or video generation model.

The video scoring machine learning model has, in some examples, been trained on human annotated training datasets that comprises a plurality of training examples, each of which comprises a video and a respective quality score for the video. The quality score for the video can be derived from human rating data. In some examples, the human rating data comprises a categorical score for the video from each of a plurality of human raters, e.g., “Good”, “Bad”, or “Borderline”. A score of “Borderline” can, in some examples, distribute the target between the two classes “Good” and “Bad”. The categorical scores can be used to generate a numerical score for the video quality. For example, a quality score between zero and one can be generated that corresponds to the likelihood of the positive class (e.g., “Good”). Any appropriate supervised learning technique known in the art can be used to train the video scoring machine learning model on the training dataset.

According to a tenth aspect, there is provided a system comprising one or more data processing apparatus and a memory. The memory stores instruction that when executed by the one or more data processing apparatus, causes the one or more data processing apparatus to carry out a method according to any of the first to ninth aspects.

According to an eleventh aspect, there is provided a non-transitory computer-readable storage medium comprising instructions that when executed by one or more data processing apparatus cause the one or more data processing apparatus to carry out a method according to any of the first to ninth aspects.

It will be appreciated that features described in the context of one aspect may be combined with features of one or more other aspects.

Particular embodiments of the subject matter described in this specification can be implemented so as to realize one or more of the following advantages.

The above-described techniques provide improvements to text-to-vision generation (e.g., text-to-image or text-to-video) systems.

By modifying user prompts during inference as described above, the modified prompts can better match the distribution of prompts used to train the text-to-vision generation system thereby providing improved visual data generation performance. Using the prompt re-writing technique can also improve the diversity of generated instances of visual data whilst maintaining user intent from the input prompt. That is, re-running the text-to-vision generation using the same user prompt multiple times (without prompt re-writing) typically results in very similar instances of visual data being generated (e.g., running the same prompt can result in very similar images being generated each time). However, re-running with prompt re-writing multiple times can produce instances of visual data having a greater variety whilst maintaining the user's original intent.

The above-described techniques can train a generative machine learning model for prompt re-writing that has low enough latency to be used at inference. The generative machine learning model can also be deployed on user devices with limited computational resources, such as limited memory, e.g., mobile devices.

Text-to-vision generation can also be improved by using a vision score conditioning signal. A vision score indicative of an image/video type or an image/video having particular characteristics can be inferred from a user prompt with a prompt scoring machine learning model. The generated image/video can therefore align better with the user's underlying intent.

Using visual scoring with two different machine learning models, that is, one that processes text descriptions and one that processes visual data to generate two scores independently, a dataset for training a text-to-vision generation system can be filtered to remove noisy data. That is, training pairs that have a mismatched text description and images/videos can be identified and removed from the training dataset thereby providing an improved text-to-vision generation system when trained on the filtered training dataset.

It will be appreciated that whilst the above techniques are described in the context of text-to-vision generation systems, the same techniques can also be used for systems of other modalities. For example, the above-described techniques can be used in conjunction with text-to-audio generation systems. As used herein, the terms “vision” and “visual data” are used to refer to images and/or videos.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic block diagram illustrating an example of a training system for a generative machine learning model.

FIG. 2 is a schematic block diagram illustrating an example of a visual data generation system.

FIG. 3 is a schematic block diagram illustrating an example of a training system for predicting vision scores.

FIG. 4A is a schematic block diagram illustrating another example of a visual data generation system.

FIG. 4B is a schematic block diagram illustrating a further example of a visual data generation system.

FIG. 5A is a schematic block diagram illustrating an example of a dataset filtering system.

FIG. 5B is a schematic block diagram illustrating an example system for generating a video quality score for an input video.

FIG. 6A is a schematic block diagram illustrating another example of a visual data generation system.

FIG. 6B is a schematic block diagram illustrating a further example of a visual data generation system.

FIG. 7 is a flowchart illustrating an example method for training a generative machine learning model according to an implementation.

FIG. 8 is a flowchart illustrating an example method for generating visual data according to an implementation.

FIG. 9 is a flowchart illustrating an example method for training a machine learning model to predict vision scores according to an implementation.

FIG. 10 is a flowchart illustrating another example method for generating visual data according to an implementation.

FIG. 11 is a flowchart illustrating an example method for filtering a dataset according to an implementation.

FIG. 12 is a flowchart illustrating another example method for generating visual data according to an implementation.

FIG. 13 is a flowchart illustrating a further example method for generating visual data according to an implementation.

FIG. 14 is a flowchart illustrating an example method for generating a video quality score for an input video according to an implementation.

Like reference numbers and designations in the various drawings indicate like elements.

### DETAILED DESCRIPTION

Text-to-image generation systems generate images by processing a user prompt that comprises instructions for generating an image. The generated image is a digital image comprising a plurality of pixels. Text-to-video generation systems similarly generate video (i.e., a sequence of images/image frames) based on a user prompt that comprises instructions for generating a video. Text-to-image/video generation systems can comprise one or more machine learning models, e.g., diffusion models, autoregressive models, consistency models or a combination thereof. Examples of diffusion models include DDIM (Denoising Diffusion Implicit Models) and latent diffusion models. In general, diffusion models such as latent diffusion models generate images/videos by using a noise removal process. An example of an autoregressive text-to-image model is PARTI (Pathways Autoregressive Text-to-Image model). An example of a consistency model for text-to-image generation can be found in J. Heek, et al., “Multistep consistency models,” arXiv preprint arXiv: 2403.06807 (2024) which is hereby incorporated by reference in its entirety. Text-to-image and text-to-video models/systems may collectively be referred to as text-to-vision models/systems.

Some text-to-image/video generation systems are trained using synthetic prompts which are typically longer and more detailed than prompts provided by a user. Training using synthetic prompts can improve the image generation capability of the system. However, as the distribution of synthetic prompts and user prompts differs, the performance of the text-to-image/video generation system may be reduced. In order to address this performance gap, a generative machine learning model such as a large language model (LLM) can be used to modify a user prompt to better align with the distribution of the synthetic prompts used to train the text-to-image/video generation system.

Some powerful LLMs can be used for this prompt re-writing task without additional training. That is, the LLM can re-write prompts through appropriate prompt engineering, e.g., by providing appropriate instructions and/or examples to the LLM. An example prompt instructing the LLM can be:
“I'm working with a text-to-image AI model and need to enhance a user prompt.
Please rewrite the prompt, following these guidelines:
Identify the core elements: subject, action, setting.
Supplement with details: environment, object properties, ambiance, potential events, stylistic cues.
Structure the prompt: clear and comprehensive format for the AI.
Word limit: 50 words maximum.
The user prompt to enhance is: <USER_PROMPT>”
   An example input user prompt and re-written prompt output by the LLM can be:
User prompt: “a photo of the london skyline”
Re-written prompt: “London skyline at sunset, viewed from a rooftop garden. Warm light bathes the cityscape, highlighting iconic landmarks in silhouette. Lush greenery frames the foreground, with a hint of the Thames shimmering in the distance. (Art style: photorealistic)”

Another example of a prompt instructing the LLM can be:

### Prompt 1:

Imagine you are tasked with improving prompts for a text-to-image generation service. Your goal is to take a user's input and rewrite it in a way that provides more specific instructions to the AI model, resulting in a richer, more visually interesting image. Take the following USER_QUERY and rewrite it, adding visual details and enhancing the scene without changing the user's core idea. Think about elements like: Camera Angle and Composition: Is this a portrait, a wide-angle shot, or a view from above? How is the subject framed within the image?
Lighting: Is the scene illuminated by natural sunlight, artificial light, or something more dramatic like a silhouette or backlighting?
What is the mood and atmosphere created by the lighting?
Style: Does the image resemble a cinematic shot, a piece of street photography, or an illustration? What artistic style would best represent the user's intent?
Background: Is the background simple and blurred, or is it a detailed environment filled with relevant objects? How does the background interact with the main subject of the image?
Ensure that every detail from the original USER_QUERY is included in your rewritten prompt.
USER_QUERY: [Insert User Query Here]

Another example of a prompt instructing the LLM can be:
You are developing an advanced text-to-image system that needs to understand nuanced descriptions. The system should take a user's simple prompt and enhance it with additional details to create a more vivid and specific image without deviating from the user's original intention.
Focus on enriching the following USER_QUERY by incorporating visual details such as: Camera Settings: Imagine specific camera settings that could be used to capture this image. Think about depth of field (blurry background vs. everything in focus), exposure time (capturing motion blur or a crisp moment), and film grain effects.
Composition: How are the elements in the scene arranged? Consider using terms like “centered,” “rule of thirds,” “leading lines,” or “symmetrical.”
Texture and Materials: If the USER_QUERY mentions objects, describe their texture and material. Is a surface rough, smooth, metallic, or wooden?
Background: Instead of simply stating a color, create a more evocative background. Is it a bustling city street, a tranquil forest, or a surreal dreamscape?
Remember to maintain the essence of the USER_QUERY while making it more visually rich.
USER_QUERY: [Insert User Query Here]

Another example prompt instructing the LLM can be:
Imagine you are an artist commissioned to create a visual representation based on a written description. Your task is to take the following USER_QUERY and transform it into a detailed prompt that captures the nuances of the original request while adding your artistic vision.
The rewritten prompt should be longer or equal in length to the original USER_QUERY. Aim for a richer description by:
Expanding on Existing Details: If the USER_QUERY mentions an object, provide additional descriptive words. For example, instead of just “a tree,” describe it as a “towering oak tree with gnarled branches and leaves tinged with autumn colors.” Incorporating Visual Elements: Translate abstract concepts into concrete visual elements. For example, if the USER_QUERY mentions “peacefulness,” think about how you can visually represent that-a calm lake, a soft, diffused light, or a muted color palette.
Choosing a Specific Style: Guide the AI model by specifying an artistic style that aligns with the USER_QUERY. Options include photorealism, impressionism, surrealism, pop art, or a specific artistic movement.
Ensure that your rewritten prompt faithfully represents all aspects of the USER_QUERY while elevating it to a more comprehensive artistic vision.
USER_QUERY: [Insert User Query Here]

Another example of a prompt instructing the LLM can be:
You are training an AI to understand the relationship between written descriptions and visual imagery. Your goal is to create high-quality prompts that produce images that are both aesthetically pleasing and faithful to the user's request.
Take the following USER_QUERY and rewrite it into a prompt optimized for a text-to-image model. Focus on the following aspects:
Descriptive Language: Use vivid language to paint a picture with words. Instead of “a blue car,” describe it as a “vintage blue convertible with gleaming chrome accents.”
Environment and Atmosphere: Create a sense of place by describing the surroundings. Is it a bustling marketplace, a desolate wasteland, or a cozy living room? What is the mood and atmosphere of the scene?
Visual Elements: Integrate specific visual elements that enhance the scene. Think about camera angles, lighting effects, textures, and color palettes.
Remember to preserve the original intent and details of the USER_QUERY while enriching the prompt with information that will help the AI generate a compelling and accurate image.
USER_QUERY: [Insert User Query Here]

However, such LLMs typically have too high latency to be used for inference time generation and/or have too large memory and computational requirements to be deployed on user devices. In this regard, the more powerful LLM can be used to train a smaller, distilled LLM that has acceptable latency at inference time and/or that can be deployed on a user device with limited computational resources. The distilled LLM (or other appropriate generative model) can be trained with a training objective of reproducing the re-written prompt output by a reference model (e.g., the more powerful LLM) for a corresponding user prompt.

Text-to-vision generation systems can also be conditioned on additional data. When a user provides a prompt to a text-to-vision generation system, the user typically has an image/video type in mind, such as a cartoon-style image or a highly photo-realistic image. As discussed above, user prompts can be short and may not explicitly express all of the user's intent. A prompt scoring machine learning model can be used to infer a vision score (e.g., an image score or video score or more generally a visual data score) from the user prompt and used as an additional conditioning signal for the text-to-vision generation system. The vision score can be indicative of a characteristic of an image/video such as the quality of an image/video.

The prompt scoring machine learning model can be trained using a second vision scoring machine learning model (which can also be known as a visual data scoring machine learning model). The vision scoring machine learning model can be trained to predict a vision score for an input image/video. The vision scoring machine learning model can be trained using human image/video preference data. That is, human reviewers can be asked to rank two or more images/videos in order of preference. This ranking can provide a vision score that can be indicative of an image/video type. Alternatively, human reviewers can be asked to provide a categorical score for an image/video, e.g., indicate whether the human reviewer considers the image/video to be “Good”, “Bad” or “Borderline”. Based on these categorical scores, a numerical vision score can be generated. For example, a quality score between zero and one can be generated that corresponds to the likelihood of the positive class (e.g., “Good”).

Using a training dataset comprising visual data and text description pairs, the vision scores provided by the image scoring machine learning model can be used as target scores for training the prompt scoring machine learning model to infer an image score from a text description alone. In this way, the prompt scoring machine learning model can be trained to provide an additional conditioning signal for text-to-vision generation.

In addition, datasets for training text-to-vision generation systems can be noisy. That is, in some cases, the text description may not match the paired image/video. The vision scoring machine learning model and the prompt scoring machine learning model can be used to filter these datasets. For example, where the image scoring machine learning model and the prompt scoring machine learning model produce different image scores, this can be indicative of a mismatching image and text description and therefore should be removed from the dataset prior to training the text-to-vision generation system.

Thus, a text-to-vision generation system can be trained using a dataset filtered by the prompt and vision scoring machine learning models and this trained text-to-vision generation system can be used in conjunction with the prompt re-writing system. In addition, or alternatively, an inferred vision score can be determined from an initial prompt or re-written prompt to be used as a conditioning signal for the text-to-vision generation.

Text-to-vision generation systems can be trained using a dataset comprising a plurality of images and/or videos. The visual data can be captured by a visual sensor of a digital camera, LIDAR, infra-red camera or any other camera type.

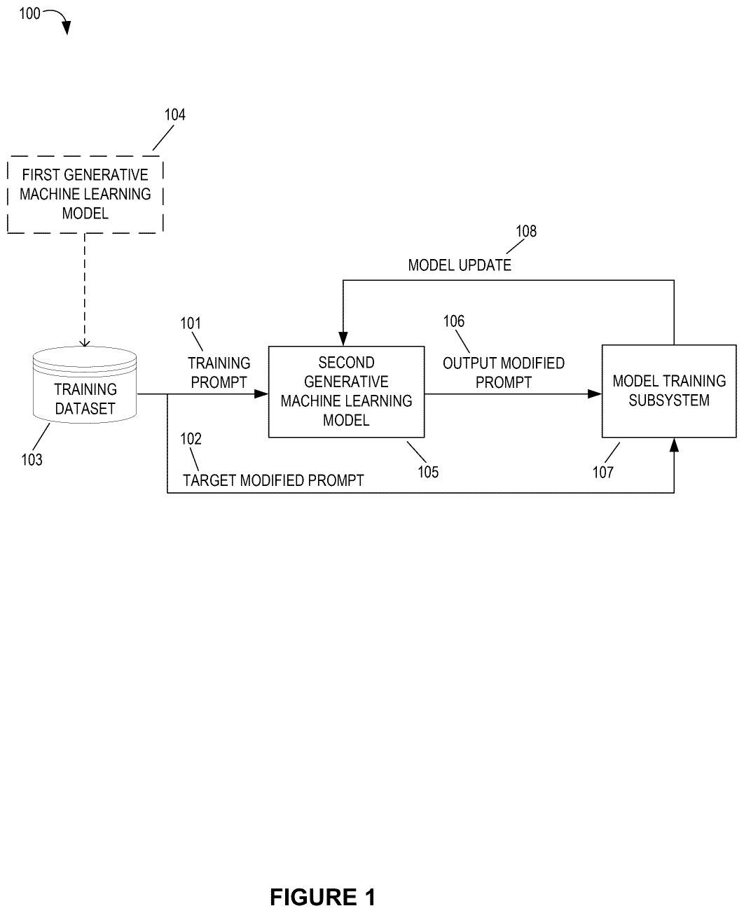

Referring now to FIG. 1, an example training system 100 for a generative machine learning model is shown. The system 100 can be implemented using one or more data processing apparatus in one or more locations. The data processing apparatus can include any appropriate hardware such as a personal computer, a server, a laptop, a mobile device or more specifically any type of processing unit such as a CPU, GPU, TPU or specialized hardware apparatus such as an FPGA or ASIC.

The system 100 is configured to obtain a training prompt 101 and a corresponding target modified prompt 102 from a training dataset 103. The training dataset 103 can be stored locally at the system 100 or can be stored remotely to the system 100 and accessed via any appropriate network connection.

The training dataset 103 comprises one or more training prompt and target modified prompt pairs generated using a first generative machine learning model 104. A training prompt 101 can be an example of a user prompt or have similar characteristics to user prompts that are typically provided to text-to-vision generation systems. Prompts provided by users are typically short and lacking in detail, for example, “a cat with big eyes”. In some text-to-vision generation systems, a generative machine learning model such as a Large Language Model (LLM) is used to re-write and expand upon the user prompt as text-to-vision generation systems typically perform better with more detailed prompts than shorter prompts. For example, the modified prompt can include additional details such as the size, breed and color of the cat can be added. In addition, details regarding the environment and scene can be generated. Other details such as the style and composition of the image/video can also be generated. The target modified prompt 102 is the re-written version of the training prompt 101 produced by the first generative machine learning model 104. Further details regarding the composition of the training dataset 103 is described in more detail below.

The system 100 comprises a second generative machine learning model 105. The second generative machine learning model 105 has a lower parameter count than the first generative machine learning model 104. The number of parameters of the second generative machine learning model 105 can be chosen according to the computational resources available on target hardware that the second generative machine learning model 105 is to be deployed on after training. For example, the second generative machine learning model 105 can be targeted for deployment on a user device such as a mobile device. The number of parameters for the second generative machine learning model 105 can be chosen such that the second generative machine learning model 105 can fit onto the storage and memory of the user device and has an acceptable latency during execution of the second generative machine learning model 105. Generally, the first generative machine learning model 104 is a powerful model that has too many parameters to be deployable on user devices or has a latency that is too long to be considered acceptable for general users. As such, a smaller model may be required. For example, the first generative machine learning model 104 can have a parameter count of the order of hundreds of billions or more. The second generative machine learning model 105 can have a parameter count of the order of one to ten billion to be deployable on (current) mobile devices.

In some implementations, the first generative machine learning model 104 can be a model that has been trained on a variety of different generative machine learning model tasks and can generally carry out other tasks in addition to prompt re-writing. The second generative machine learning model 105 can be a model that has also been trained to carry out different generative machine learning model tasks. In this regard, the training carried out by the system 100 on the second generative machine learning model 105 can be considered to be a fine-tuning of the second generative machine learning model 105 on the task of prompt re-writing. As such, the second generative machine learning model 105 can be a pre-trained model. The first generative machine learning model 104 and the second generative machine learning model 105 can be a foundation model, an LLM-type machine learning model or a multi-modal version of an LLM. Pre-training of generative machine learning models such as LLMs are described in more detail below.

Referring back to FIG. 1, the system 100 is configured to process the training prompt 101 using the second generative machine learning model 105 to generate an output modified prompt 106 (i.e., a modified prompt 106 is output by the second generative machine learning model 105). As discussed above, the training prompt 101 can be modified to have increased similarity to prompts used to train a text-to-vision generation system. For example, the second generative machine learning model 105 can attempt to expand upon the training prompt 101 to provide additional details in the output modified prompt 106. In some implementations, the system 100 can provide instructions to the second generative machine learning model 105 as to how to modify the training prompt 101. Examples of such instructions are provided above.

The system 100 is further configured to update the second generative machine learning model 105 using a training objective based upon the output modified prompt 106 and the target modified prompt 102. The training objective can be based upon knowledge distillation techniques such as those described in Hinton, Geoffrey et. al, “Distilling the Knowledge in a Neural Network,” arXiv preprint arXiv: 1503.02531 (2015) which is hereby incorporated by reference in its entirety. For example, the target modified prompt 102 can be used as a “hard target” and the training objective can be a loss function constructed based upon the output modified prompt 106 as compared to the target modified prompt 102. In other examples, a “soft target” can be used. A soft target can be the probability distribution, logits or other set of scores over the output token vocabulary generated by the first generative machine learning model 104 in producing the target modified prompt 102. In this regard, a training pair can also include the corresponding soft target. The training objective can be a loss function constructed based upon the soft target associated with the target modified prompt 102 and the corresponding distribution/scores generated by the second generative machine learning model 105 in producing the output modified prompt 106. For both hard and soft targets, the loss function can be any appropriate loss function such as a cross-entropy loss or mean-squared error for example.

The system 100 can include a model training subsystem 107 configured to determine a model update 108 based upon the training objective. The model update 108 can be determined using any appropriate technique for the type of machine learning model. For example, the model update 108 can be determined using backpropagation and stochastic gradient descent for a neural network. In some implementations, the model update 108 only corresponds to a subset of the parameters of the second generative machine learning model 105. That is, some of the parameters of the second generative machine learning model 105 can be held frozen and not updated. In some implementations, the second generative machine learning model 105 is updated based upon a parameter efficient fine-tuning technique (PEFT). For example, the second generative machine learning model 105 can be initialized based upon a pre-trained model as described above. The parameters of the pre-trained model can be frozen and a small number of additional parameters can be added to the model and only these additional parameters are updated by the model update 108. In some implementations, the additional parameters take the form of adapter modules which are further described in Houlsby, Neil, et al., “Parameter-efficient transfer learning for NLP,” International conference on machine learning. PMLR, 2019, and is hereby incorporated by reference in its entirety. In another example, the model update 108 can be based upon low rank adaptation (LoRA). In LoRA, the additional parameters are based upon a rank decomposition, for example, the additional parameters for a layer can be represented as a multiplication of two low rank matrices. Further details can be found in Hu, Edward J., et al., “LoRA: Low-rank adaptation of large language models,” ICLR 1.2 (2022): 3, which is hereby incorporated by reference in its entirety.

The system 100 can be configured to apply the model update 108 to the second generative machine learning model 105 to update the parameters of the second generative machine learning model 105. The system 100 can be configured to repeat the training process using further training pairs obtained from the training dataset 103 and can involve a plurality of iterations over the training dataset 103. The training process can continue until convergence or a fixed number of training steps have been carried out or other stopping criterion has been reached.

After training, the second generative machine learning model 105 can be deployed for use in re-writing user prompts for a text-to-vision generation system. In some implementations, the second generative machine learning model 105 is deployed on a (resource-constrained) user device such as a mobile device. The system 100 can be configured to transmit the second generative machine learning model 105 to the user device for deployment. The system 100 can be configured to store the second generative machine learning model 105 for subsequent transmittal. The second generative machine learning model 105 can be deployed on one or more user devices. In some implementations, the system 100 itself can deploy the second generative machine learning model 105 for use in conjunction with a text-to-vision generation system. In these implementations, the system 100 can use the second generative machine learning model 105 to reduce the amount of memory and/or latency required for prompt re-writing compared to using the first generative machine learning model 104. The second generative machine learning model 105 can also be deployed on non-user devices such as a cloud server for providing a prompt re-writing service with reduced memory consumption and/or latency.

In some implementations, the first generative machine learning model 104 can have a Mixture of Experts architecture, that is, the first generative machine learning model 104 can comprise a plurality of “expert” models. Typically, a subset of the expert models (though in some cases all of the expert models) are selected and used to process an input to generate an output. In some implementations, the second generative machine learning model 105 can be a dense architecture (e.g., is composed of a single model). The first generative machine learning model 104 and the second generative machine learning model 105 can comprise a plurality of neural network layers such as attention-based layers/Transformer blocks.

In some implementations, the system 100 can be configured to generate the training dataset 103. In more detail, the system 100 can be configured to obtain one or more user prompts and for each of the one or more user prompts, the system 100 can be configured to generate, using the first generative machine learning model 104, one or more modified user prompts to generate one or more candidate training pairs and to add the candidate training pairs to the training dataset 103. That is, a candidate training pair can comprise a user prompt and a modified version of the user prompt that is generated by the first generative machine learning model 104. Where a plurality of modified user prompts are generated for a user prompt, each modified user prompt can form a separate candidate pair with the original user prompt. The original user prompt can therefore be the training prompt 101 and the modified user prompt can be the target modified prompt 102.

In some implementations, the system 100 can provide instructions to the first generative machine learning model 104 for how to generate the one or more modified user prompts. In some implementations, the system 100 can be configured with a plurality of different sets of instructions to provide greater diversity in the generated modified user prompts. Examples of instructions are provided above.

In some implementations, the system 100 can be configured to filter the candidate training pairs prior to adding the candidate training pairs to the training dataset 103. As such, some candidate training pairs will be filtered out and not be added to the training dataset 103. The filtering can be based upon determining whether the modified user prompt entails the original user prompt using a natural language understanding technique. In general, given a pair of text fragments, a premise P and hypothesis H, entailment means that His necessarily true or appropriate when P is true. For example, the premise could be “I have a cat” and the hypothesis could be “I have a pet”. Thus, P entails H. A contradiction means H is necessarily false or inappropriate whenever P is true. For example, the premise could be “The cat sat on the mat” and the hypothesis could be “The cat did not sit on the mat”. Thus, P does not entail H, P contradicts H. In addition, there can also be a third class where P and H are unrelated. For example, the premise could be “I saw a cat” and the hypothesis could be “I wrote my essay”. Thus, neither P entails H or P contradicts H. In some instances, this task is referred to as “textual entailment” or “natural language inference”. Further details can be found in Parikh, A. P., Täckström, O., Das, D. and Uszkoreit, J., A decomposable attention model for natural language inference, arXiv preprint arXiv: 1606.01933, 2016, which is hereby incorporated by reference in its entirety.

In addition, or alternatively, the filtering can be used upon obtained human feedback with respect to the generated candidate pairs. For example, human reviewers can be shown the original user prompt and the modified user prompt and asked to consider whether the modified user prompt entails the original user prompt and/or whether the modified user prompt does not introduce any inconsistencies or inaccuracies.

In some implementations, only a portion of the generated candidate pairs are reviewed by humans. Training dataset 103 can therefore comprise a first portion of the training data that is generated by the first generative machine learning model 104 that has not been filtered using human feedback (but could still have been filtered by automated means such as an automated entailment analysis) and a second portion of the training data that is generated by the first generative machine learning model 104 that has been filtered using human feedback. In some implementations, the generated candidate pairs are first automatically filtered before human feedback is requested. As such, the second portion of the training data can be both automatically filtered and human filtered.

In some implementations, the training dataset 103 can comprise a third portion of the training data that comprises pairs of human generated captions and synthetically generated captions for a plurality of images/video obtained from a further training dataset for training a text-to-vision generation system. In general, text-to-vision generation systems can be trained using datasets having human generated captions, for example, these can be extracted from alt-text data present in images/video on the Internet. In some implementations, the image/video is also re-captioned using an image/video captioning machine learning model to generate synthetic captions that describe the image/video. The synthetic captions can include more detail than the human generated captions and therefore the human generated caption and the synthetic caption can form suitable pairs for inclusion in the prompt re-writing training dataset 103.

It will be appreciated that the training dataset 103 can comprise any combination of the first, second and third portions of training data. That is, the training dataset 103 can comprise the first portion and the third portion of training data without the second portion and any other combination thereof. In this regard, a portion of training data can also be viewed as a category of training data. It will also be appreciated that the training dataset 103 can include further data in addition to the first, second and third portions.

In some implementations, each portion of the training dataset 103 is associated with a sampling weight. As such, when the system 100 attempts to obtain a training prompt 101 and corresponding target modified prompt 102 from the training dataset 103, this can be carried out by sampling a training pair from the training dataset based upon the sampling weight for each portion. In some implementations, the second portion has the largest sampling weight. As the second portion has been reviewed by humans, this portion of data is likely to have the highest quality. In some implementations, the third portion has the lowest sampling weight. As discussed above, the third portion of data can comprise human generated captions extracted from alt-text data of images/video on the Internet. This alt-text data can be inaccurate (hence the use of re-captioning to generate synthetic captions). The third portion is therefore likely to have the lowest quality of the three portions.

In some implementations, the output of the first generative machine learning model 104 can be constrained based upon a finite state transducer. For example, the finite state transducer can ensure that the first generative machine learning model 104 provides an output that conforms to a particular format, e.g., JSON. In another example, the finite state transducer can ensure that the first generative machine learning model 104 provides a specified number of modified prompts per input prompt.

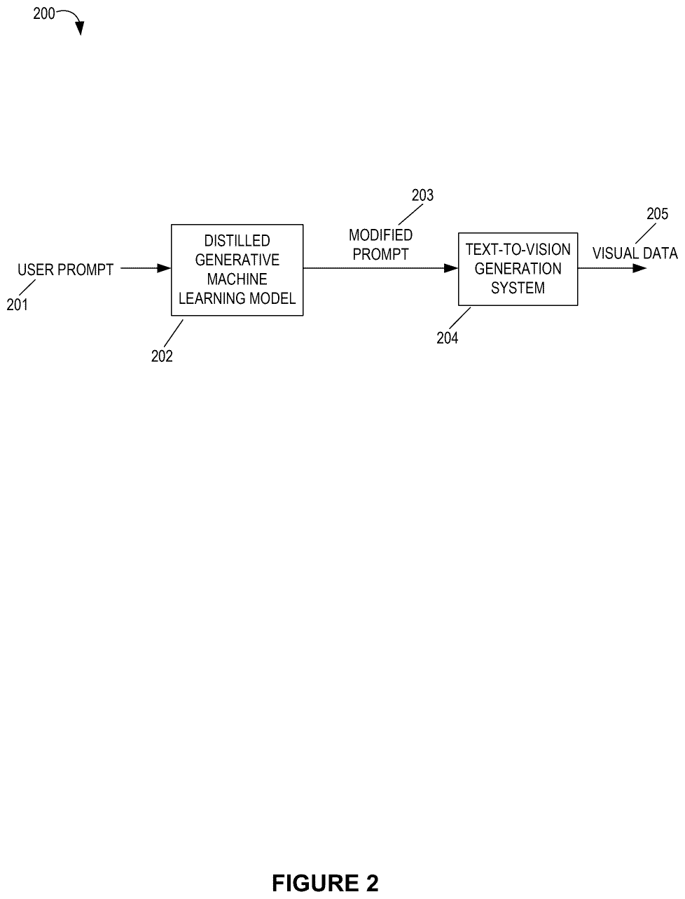

Referring now to FIG. 2, an example visual data generation system 200 is shown. The system 200 can be implemented using one or more data processing apparatus in one or more locations. The data processing apparatus can include any appropriate hardware such as a personal computer, a server, a laptop, a mobile device or more specifically any type of processing unit such as a CPU, GPU, TPU or specialized hardware apparatus such as an FPGA or ASIC.

In some implementations, the training system 100 and the visual data generation system 200 can be the same system. In other implementations, the training system 100 and the visual data generation system 200 are different systems. For example, the training system 100 can be implemented on a remote server and the visual data generation system 200 can be implemented on a user device such as a mobile device.

The system 200 is configured to obtain a user prompt 201. The user prompt 201 comprises instructions for generating visual data such as an image or a video using a text-to-vision generation system. The user prompt 201 can include a text description in natural language of objects and entities, and more generally, of a scene to be depicted in the visual data. The user prompt 201 can be received from a user device if the system 200 is a remote system. Otherwise, the system 200 can include an interface for a user to enter a user prompt 201.

The system 200 comprises a distilled generative machine learning model 202. The distilled generative machine learning model 202 has been trained using a dataset generated by a reference generative machine leaning model. For example, the distilled generative machine learning model 202 can be the trained second generative machine learning model 105 from FIG. 1 and the reference generative machine learning model can be the first generative machine learning model 104 from FIG. 1. As discussed above, the second generative machine learning model 105 is trained using a training dataset 103 comprising training pairs generated by the first generative machine learning model 104.

The reference generative machine learning model has a larger parameter count than the distilled generative machine learning model 202. The distilled generative machine learning model 202 therefore has a lower storage and memory requirement and can have lower latency compared to the reference generative machine learning model. The reference generative machine learning model and the distilled generative machine learning model 202 can have the same general architecture, for example, both models can be based upon Transformer neural network architectures.

The system 200 is configured to process the user prompt 201 using the distilled generative machine learning model 202 to generate a modified prompt 203. As described above, user prompts are typically short and lacking in detail. As described above, some text-to-vision generation systems are trained on synthetic prompts that are generally longer and more detailed and/or some text-to-vision generation systems can perform better when provided with more detailed instruction. As such, the distilled generative machine learning model 202 can generate a modified version of the user prompt that includes more detail to provide a better match to the distribution of prompts used to train the text-to-vision generation system and/or to enhance the performance of text-to-vision generation system. The distilled generative machine learning model can be provided with instructions on how to modify a user prompt.

The system 200 comprises a text-to-vision generation system 204 (e.g., a text-to-image generation system or a text-to-video generation system). The system 200 is configured to generate visual data 205 (e.g., an image or video) based upon the modified prompt 203 using the text-to-vision generation system 204. The generated visual data 205 can depict the objects/entities specified in the user prompt 201 and any additional details contained in the modified prompt 203. The text-to-vision generation system 204 can include any appropriate machine learning model capable of generating visual data conditioned on input text. For example, the visual data generation machine learning model can comprise one or more diffusion neural networks (also known as denoising neural networks) such as DDIM (Denoising Diffusion Implicit Models) and DDPM (Denoising Diffusion Probabilistic Models). Further details with respect to these models are described in more detail below. The text-to-vision generation system 204 can be a multi-modal large language model-based system and can be capable of generating outputs of other modalities such as audio and text as well as visual data and/or is capable of conditioning generation on other modalities such as audio, and on other images/video.

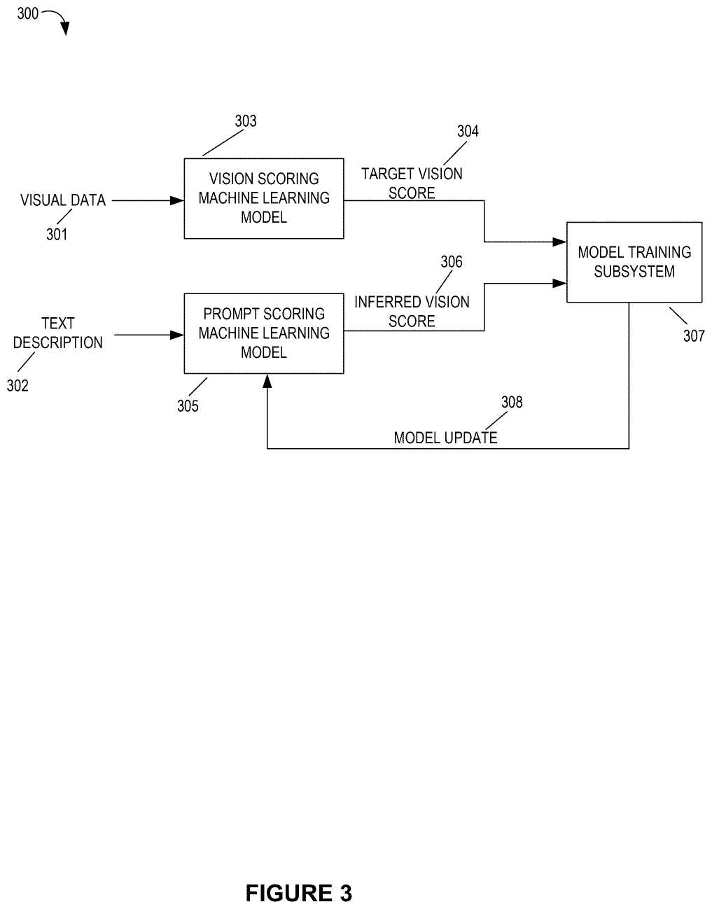

Referring now to FIG. 3, an example training system 300 for predicting vision scores (e.g., an image score or a video score or more generally a visual data score) is shown. The system 300 can be implemented using one or more data processing apparatus in one or more locations. The data processing apparatus can include any appropriate hardware such as a personal computer, a server, a laptop, a mobile device or more specifically any type of processing unit such as a CPU, GPU, TPU or specialized hardware apparatus such as an FPGA or ASIC.

The system 300 is configured to obtain visual data 301 and a corresponding text description 302. The visual data 301 can be an image or a video for example. The visual data 301 and text description 302 can be part of a training dataset of visual data and text description pairs. In some implementations, the text description 302 can be a user prompt that was used to generate the corresponding visual data 301 or the text description 302 can be a re-written user prompt. In other implementations, the text description 302 can be a caption for the visual data 301 which can be a human annotation or generated by an image/video captioning machine learning model. The training dataset can be stored locally at the system or stored remotely.

The system 300 comprises a vision scoring machine learning model 303. The system 300 is configured to process the visual data 301 using the vision scoring machine learning model 303 to generate a target vision score 304 (i.e., a target image/video/visual data score). In some implementations, the vision scoring machine learning model 303 has been trained based upon vision scoring data generated from human image preference data or human video preference data. For example, human reviewers can be asked to rank two or more images/videos in order of preference. Typically, human reviewers will rank high-quality photo-realistic images/videos higher than a cartoon-style images/videos. As such, the rank can be indicative of a type of image/video or the quality of an image/video. Alternatively, human reviewers can be asked to carry out the ranking on the basis of a particular attribute or characteristic. The ranking data can therefore provide an ordering of images/videos according to a type, quality or other attribute/characteristic and a vision scoring machine learning model trained on this human preference data can learn a distribution of scores that reflects the type of image/video, its quality or other attribute/characteristic. In this regard, the vision scoring machine learning model 303 can be trained using a training objective based upon a Bradley-Terry model when ranking data is used.

The vision scoring machine learning model 303 can be any appropriate machine learning model. For example, the vision scoring machine learning model 303 can comprise a feedforward neural network. In some implementations, the feedforward neural network comprises a single hidden layer.

The system 300 comprises a prompt scoring machine learning model 305. The system 300 is configured to process the text description 302 using the prompt scoring machine learning model 305 to generate an inferred vision score 306 for the text description 302. The system 300 is configured to update the prompt scoring machine learning model 305 using a training objective based upon the inferred vision score 306 and the target vision score 304. That is, the prompt scoring machine learning model 305 can be trained to predict the corresponding vision score from the text description 302 alone. As described in more detail below, the inferred vision score produced by a prompt scoring machine learning model can be used as additional conditioning data for generating visual data (e.g., image or video data) by a text-to-vision generation system given that an inferred vision score can provide an indication of an expected type, quality or other attribute/characteristic of the visual data to be generated from a user prompt that may not be explicitly specified in the user prompt.

The prompt scoring machine learning model 305 can be any appropriate machine learning model. For example, the prompt scoring machine learning model 305 can comprise one or more Transformer-based neural network blocks.

The system 300 can comprise a model training subsystem 307 that is configured to determine a model update 308. The system 300 can be configured to apply the model update 308 to the prompt scoring machine learning model 305. The training objective can be a regression-based training objective. For example, a loss function based upon a mean squared error between the target vision score 306 and inferred vision score 304 can be used. The model update 308 can be determined using any appropriate technique for the type of machine learning model. For example, the model update 308 can be determined using backpropagation and stochastic gradient descent for a neural network. The system 300 can be configured to repeat the training process using further visual data and text description pairs and can involve a plurality of iterations over the training dataset. The training process can continue until convergence or a fixed number of training steps have been carried out or other stopping criterion has been reached. After training, the prompt scoring machine learning model 305 can be deployed for use in a text-to-vision generation system as described below.

In some implementations, the visual data 301 can be encoded using an embedding of the visual data. An embedding refers to an ordered collection of numerical values, e.g., a vector or matrix of numerical values that represents an input in a particular embedding/encoding space. In some implementations, the text description 302 can be encoded using a text embedding. The system 300 can be configured to generate the embedding of the visual data/text or the embedding can be generated by an external system. The embedding can be pre-generated and provided in the training dataset or subsequently transmitted to the system 300. The vision scoring machine learning model 303 can be configured to process the embedding of the visual data using the vision scoring machine learning model 303 to generate the target vision score 306. The prompt scoring machine learning model 305 can be configured to process the embedding of the text description to generate the inferred vision score 304.

The embedding of the visual data/text can be a contrastive embedding. Generally, a contrastive embedding is obtained using a model that has been trained to produce visual data and text representations in the same embedding space based on a contrastive training objective. The contrastive training objective attempts to bring the visual data and text embeddings of matching pairs closer together in the embedding space and push apart visual data and text embeddings of non-matching pairs in the embedding space. As such, the embedding space can be configured to provide that semantically similar visual data and text have similar embeddings. Two example contrastive embedding techniques are CLIP, the details of which can be found in “Radford, Alec, et al., “Language models are unsupervised multitask learners,” OpenAI blog 1.8 (2019): 9, and ALIGN, the details of which can be found in “Jia, Chao, et al., “Scaling up visual and vision-language representation learning with noisy text supervision” International conference on machine learning. PMLR, 2021, both of which are incorporated by reference in their entirety.

Where the visual data is video, an embedding can be generated based upon subsets of frames of the video. For example, generating a subset of frames of the video can comprise sampling every N-th frame of video, where N>1 and processing the subset of frames of the video using an embedding model to generate the embedding of the video (visual data). In some examples, N corresponds to a predefined framerate, e.g., 1 frame per second. In some examples, N corresponds to a fixed predefined number, e.g., N frames of the video are taken, irrespective of the video length. The embedding model can comprise a contrastive embedding model, such as CLIP or ALIGN as described above. In some examples, processing the subset of frames of the video using a video embedding model to generate an embedding of the video comprises processing each frame of the subset of frames of the video using the video embedding model to generate a respective frame embedding for each frame of the subset of frames. The respective frame embeddings can then be concatenated to generate the embedding of the video.

In some implementations, the system 300 can be configured to select pairs of images/videos for human reviewers to rank to generate the human image/video preference data. For example, visual data from a dataset can be clustered such that semantically similar visual data are close together. The clustering can be carried out based upon an embedding for each instance of visual data, such as a CLIP embedding or an ALIGN embedding as discussed above (e.g., an embedding for each image or an embedding for each video can be generated and then clustered). Pairs of images/videos that are part of the same cluster or have a minimum threshold distance apart can be sampled and provided to human reviewers. In this way, each pair of images/videos should have similar content to enable an easier comparison. It will be appreciated that more than two images/videos can be sampled from each cluster and provided to human reviewers. In some implementations, the dataset for carrying out the clustering can be the same dataset from which the visual data and text description pairs are obtained from or can be a further dataset of visual data (which may or may not have corresponding text descriptions).

In some implementations, the target and inferred vision scores are continuous valued numbers. In some implementations, the image score is in the range 0 to 10 inclusive. It will be appreciated that vision scores can have any appropriate range deemed suitable by a person skilled in the art.

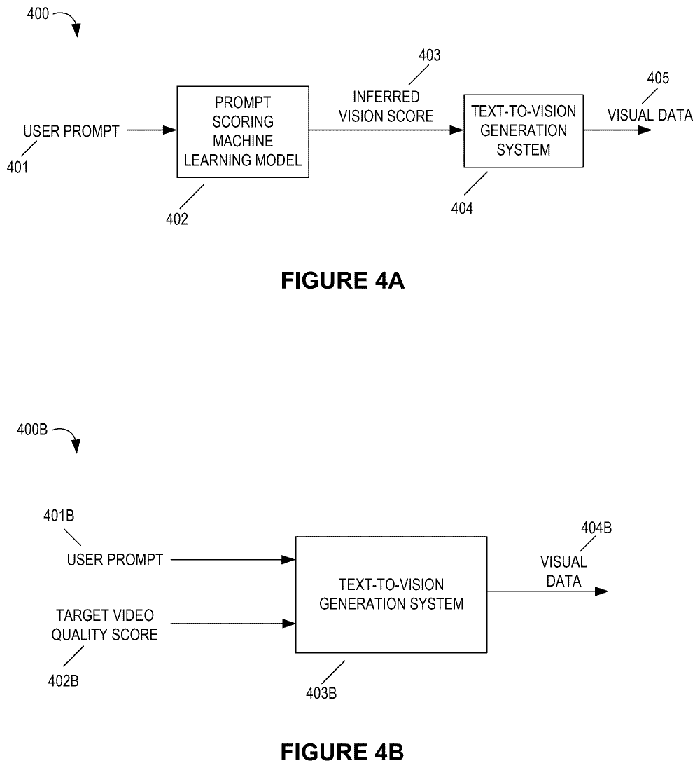

Referring now to FIG. 4A, another example visual data generation system 400 is shown. The system 400 can be implemented using one or more data processing apparatus in one or more locations. The data processing apparatus can include any appropriate hardware such as a personal computer, a server, a laptop, a mobile device or more specifically any type of processing unit such as a CPU, GPU, TPU or specialized hardware apparatus such as an FPGA or ASIC.

In some implementations, the training system 300 and the visual data generation system 400 can be the same system. In other implementations, the training system 300 and the visual data generation system 400 are different systems. For example, the training system 300 can be implemented on a remote server and the visual data generation system 400 can be implemented on a user device such as a mobile device.

The system 400 is configured to obtain a user prompt 401 comprising instructions for generating visual data using a text-to-vision generation system. The user prompt 401 can include a text description in natural language of objects/entities and more generally, of a scene to be depicted in an image/video. The user prompt 401 can be received from a user device if the system 400 is a remote system. Otherwise, the system 400 can include an interface for a user to enter a user prompt 401.

The system comprises a prompt scoring machine learning model 402. The prompt scoring machine learning model 402 can be the prompt scoring machine learning model 305 from FIG. 3 and trained as described above.

The system 400 is configured to process, using the prompt scoring machine learning model 402, the user prompt 401 to generate an inferred vision score 403. As discussed above, the inferred vision score 402 can provide an additional signal regarding the visual data that is to be generated that may not be explicit from the user prompt 401. For example, the inferred vision score 403 could be indicative of a type of or quality of an image/video to be generated or represent another particular attribute or characteristic of the image/video.

The system 400 is configured to generate, using the text-to-vision generation system 404, visual data 405 based upon the user prompt 401 and the inferred vision score 403. The generated visual data 405 can depict the objects/entities specified in the user prompt 401 and be generated according to the particular attributes and characteristics indicated by the inferred vision score 403.

In some implementations, a range of vision scores is determined from the inferred vision score 403 and the visual data 405 is generated based upon the range of vision scores. For example, the inferred vision score 403 can be set as a lower bound and the range of vision scores can range from the inferred vision score 403 to the highest possible vision score.

The text-to-vision generation system 404 can include any appropriate machine learning model capable of generating visual data conditioned on input text and additional data such as a vision score. For example, the visual data generation machine learning model can comprise one or more diffusion neural networks (also known as denoising neural networks) such as DDIM (Denoising Diffusion Implicit Models) and DDPM (Denoising Diffusion Probabilistic Models). The text-to-vision generation system 404 can be a multi-modal large language model-based system and can be capable of generating outputs of other modalities such as audio and text as well as visual data and/or is capable of conditioning generation on other modalities such as audio and on other images/video.

Referring now to FIG. 4B, another example visual data generation system 400B is shown. In some implementations, the system 400B and the system 400 of FIG. 4A can be the same system. In other implementations, the two systems are implemented as different systems. The system 400B can be implemented using one or more data processing apparatus in one or more locations. The data processing apparatus can include any appropriate hardware such as a personal computer, a server, a laptop, a mobile device or more specifically any type of processing unit such as a CPU, GPU, TPU or specialized hardware apparatus such as an FPGA or ASIC.

The system 400B is configured to obtain a user prompt 401B comprising instructions for generating video using a text-to-vision generation system. The user prompt 401B can include a text description in natural language of objects, entities and actions that are to occur in the video. The user prompt 401B can be received from a user device if the system 400B is a remote system. Otherwise, the system 400B can include an interface for a user to enter a user prompt 401B.

The system 400B is configured to obtain a target video quality score 402B. The target video quality score can be a vision (video) score as described above that is indicative of a target quality of the video that is to be generated. In some implementations, the target video quality score 402B is a numerical value between zero and one. It will be appreciated however that any suitable values can be used as deemed appropriate by a person skilled in the art.

The system 400B is configured to process, using the text-to-vision generation system 403B, the user prompt 401B and the target video quality score 402B to generate an output set of visual data (e.g., video data) 404B, wherein the quality of the output set of visual data 404B corresponds to the target video quality score 402B. In some implementations, the text-to-vision generation system 403B comprises a latent diffusion model. Latent diffusion models are described in more detail below.

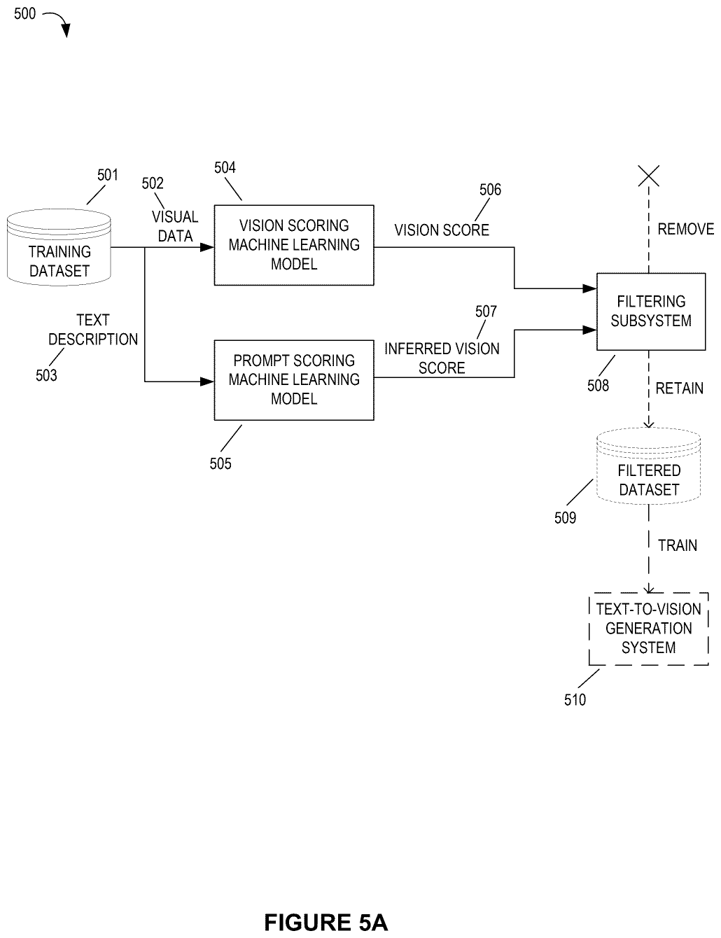

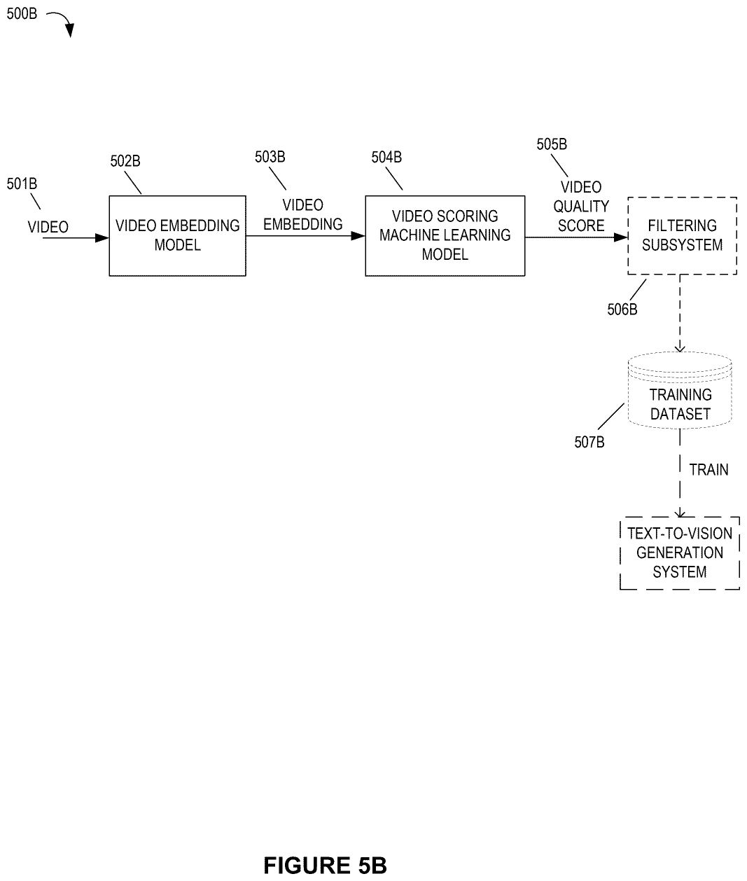

Referring now to FIG. 5A, an example dataset filtering system 500 is shown. The system 500 can be implemented using one or more data processing apparatus in one or more locations. The data processing apparatus can include any appropriate hardware such as a personal computer, a server, a laptop, a mobile device or more specifically any type of processing unit such as a CPU, GPU, TPU or specialized hardware apparatus such as an FPGA or ASIC.

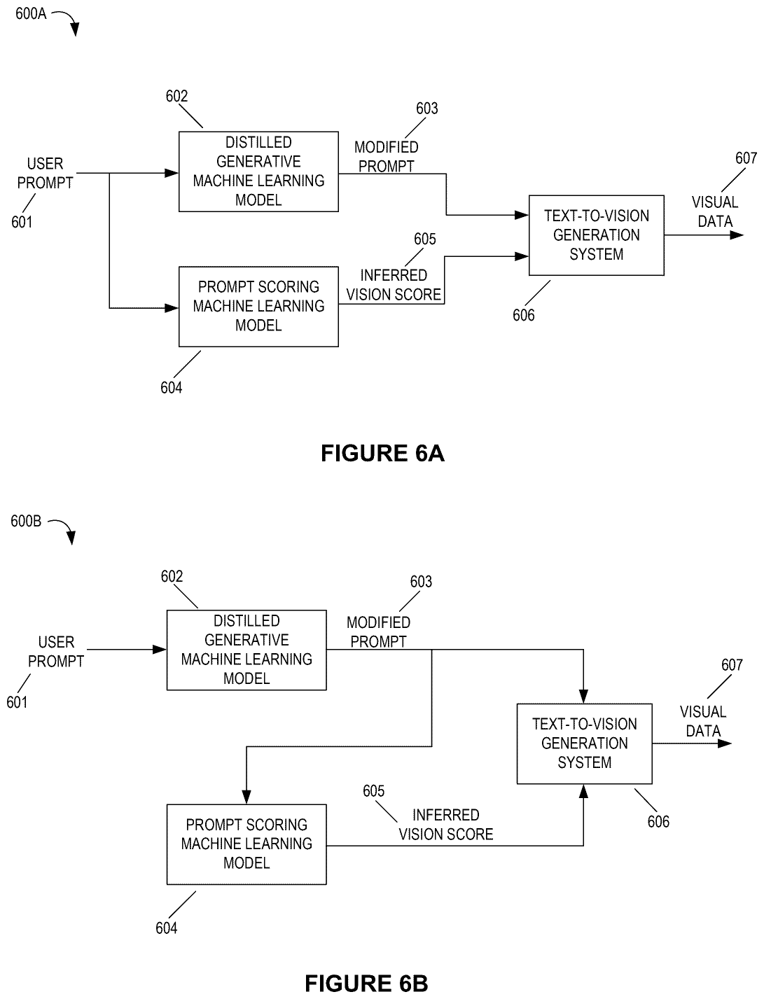

The dataset filtering system 500 can be combined with any of the systems described in FIGS. 1 to 4A and 4B above and the systems described in FIGS. 6A and 6B below.

The system 500 is configured to obtain a dataset 501 that comprises a plurality of instances of visual data 502 (e.g., an image or video) and text description 503 pairs. The dataset 501 can be stored locally at the system 500 or stored remotely to the system 500 and accessed via any appropriate network connection.

The system 500 is configured to filter the dataset 501. In this regard, the system 500 comprises a vision scoring machine learning model 504. The vision scoring machine learning model 504 can be the same vision scoring machine learning model 303 as in FIG. 3. The system 500 is configured to process, using the vision scoring machine learning model 504, visual data 502 of a training pair to generate a vision score 505. As described above, the vision score 505 can be indicative of a type, quality or other attribute/characteristic of the visual data 502.

The system 500 comprises a prompt scoring machine learning model 506. The prompt scoring machine learning model 506 can be the same as the prompt scoring machine learning model 305 of FIG. 3 and/or the prompt scoring machine learning model 402 of FIG. 4A. The system 500 is configured to process, using the prompt scoring machine learning model 506, the corresponding text description 503 of the training pair to generate an inferred vision score 507. As described above, the prompt scoring machine learning model 506 can be trained to generate a prediction of the vision score 505 of the corresponding visual data 502 from the text description 503 only.

The system 500 is further configured to determine whether to remove or keep the training pair based upon a comparison between the vision score 505 and the inferred vision score 507. For example, as described above, some datasets can comprise visual data obtained from the Internet with text descriptions obtained from corresponding alt-text fields. The alt-text data can however be inaccurate. In such cases, the vision score 505 (generated from the visual data 502) and the inferred vision score 507 (generated from the text description 503) may be inconsistent. Visual data and text description pairs that have inconsistent vision and inferred vision scores can be filtered out of the dataset 501 to reduce the noise in the dataset.

In some implementations, the system 500 can be configured to keep the visual data 502 and text description 503 pair when the vision score 505 and inferred vision score 507 are within a pre-determined range of each other. Otherwise, the system 500 can be configured to remove the pair. In some implementations, the system 500 can be configured to remove the pair when the vision score 505 and/or inferred vision score 507 are themselves outside of a certain range of values. As described above, the vision and inferred vision scores can be indicative of an attribute/characteristic of the visual data and as such, the vision and inferred vision scores can be used to select for certain attributes/characteristics. The system 500 can comprise a filtering subsystem 508 configured to determine whether to keep or remove a pair.

The system 500 can be configured to process further visual data 502 and text description 503 pairs. In FIG. 5A, pairs that are kept are shown as being stored in a separate filtered dataset 509. Alternatively, pairs that are to be removed can be deleted from the original dataset 501 or each pair can be associated with a flag that indicates whether the pair is to be kept (usable) or to be removed (unusable). The filtered dataset 509 (or the modified version of the original dataset) can be used to train a text-to-vision generation system 510 such as the text-to-vision generation systems of FIGS. 2, 4A, and 4B or the text-to-vision generation systems of FIGS. 6A and 6B below. In some implementations, the system 500 can be configured to carry out the training.

Referring now to FIG. 5B, an example system 500B for generating a video quality score for an input video is shown. The system 500B can be implemented using one or more data processing apparatus in one or more locations. The data processing apparatus can include any appropriate hardware such as a personal computer, a server, a laptop, a mobile device or more specifically any type of processing unit such as a CPU, GPU, TPU or specialized hardware apparatus such as an FPGA or ASIC.

The system 500B is configured to obtain a video 501B for scoring. The system 500B comprises a video embedding model 502B and the system 500B is configured to process the video 501B using the video embedding model 502B to generate an embedding 503B of the video. In some implementations, the system 500B is configured to generate the embedding 503B of the video by generating a subset of frames of the video 501B comprising sampling every N-th frame of video, wherein N>1, and processing the subset of frames of the video using a video embedding model to generate the embedding 503B of the video. In some examples, N corresponds to a predefined framerate, e.g., 1 frame per second. In some examples, N corresponds to a fixed predefined number, e.g., N frames of the video are taken, irrespective of the video length. The embedding model can comprise a contrastive embedding model, such as CLIP or ALIGN as described above. In some examples, processing the subset of frames of the video using a video embedding model to generate an embedding of the video comprises processing each frame of the subset of frames of the video using the video embedding model to generate a respective frame embedding for each frame of the subset of frames. The respective frame embeddings can then be concatenated to generate the embedding of the video.

The system 500B further comprises a video scoring machine learning model 504B and the system 500B is configured to process the embedding 503B of the video using the video scoring machine learning model 504B to generate a video quality score 505B for the video. In some implementations, the video scoring machine learning model 504B comprises a feedforward neural network. In some implementations, the feedforward neural network comprises two hidden layers.

In some implementations, the system 500B can be further configured to compare the video quality score 505B for the video to a threshold video score. In response to determining that the video quality score 505B is above the threshold video score, the system 500B can be configured to include the video 501B in a training dataset 507B comprising a plurality of videos. Otherwise, the system 500B can be configured to refrain from including the video in the training dataset. The threshold quality score is, in some examples where the score is constrained to be between zero and one, at least 0.5, e.g., at least 0.6, for example. 0.7.

The system 500B can further comprise a filtering subsystem 506B configured to carry-out the above filtering operations. The training dataset can be used to train any of the text-to-vision generation systems disclosed herein or be used to train a video processing machine learning model.

In some implementations, the video scoring machine learning model 504B has been trained on human annotated training datasets that comprises a plurality of training examples, each of which comprises a video and a respective quality score for the video. The quality score for the video can be derived from human rating data. In some examples, the human rating data comprises a categorical score for the video from each of a plurality of human raters, e.g., “Good”, “Bad”, or “Borderline”. A score of “Borderline” can, in some examples, distribute the target between the two classes “Good” and “Bad”. The categorical scores can be used to generate a numerical score for the video quality. For example, a quality score between zero and one can be generated that corresponds to the likelihood of the positive class (e.g., “Good”). Any appropriate supervised learning technique known in the art can be used to train the video scoring machine learning model on the training dataset.

Referring now to FIGS. 6A and 6B, in some implementations, the visual data generation system 200 of FIG. 2 and the visual data generation system 400 of FIG. 4A can be combined. One such combination is shown in FIG. 6A.

The system 600A is configured to obtain a user prompt 601 comprising instructions for generating visual data as described above. The system 600A comprises a distilled generative machine learning model 602 and the system 600A is configured to modify the user prompt 601 using the distilled generative machine learning model 602 to generate a modified user prompt 603 as described above. The system 600A further comprises a prompt scoring machine learning model 604. The system 600A is configured to process the user prompt 601 to generate an inferred vision score 605 as described above. The system 600A comprises a text-to-vision generation system 606. The system 600A is configured to generate visual data 607 using the text-to-vision generation system 606 based on the modified prompt 603 and the inferred vision score 605 as described above.

FIG. 6B provides an alternative example, system 600B, in which all components are identical to system 600A except that system 600B is configured to process the modified prompt 603 using the prompt scoring machine learning model 604 to generate the inferred vision score 605.

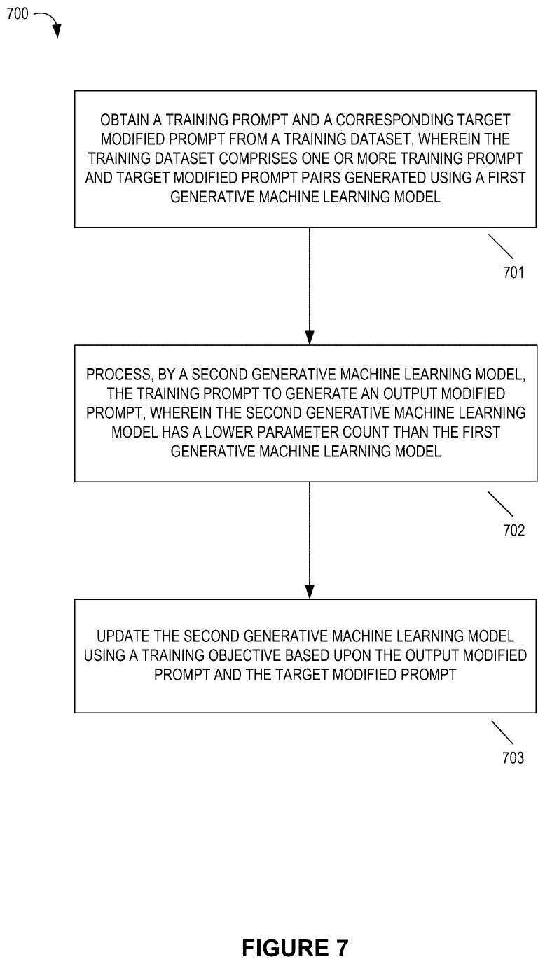

FIG. 7 is a flow diagram illustrating an example method 700 for training a generative machine learning model. The processing shown in FIG. 7 can be implemented using the training system of FIG. 1. As such, features described in the context of FIG. 1 can also be applied to the method of FIG. 7.

At step 701, a training prompt and a corresponding target modified prompt are obtained from a training dataset. The training dataset comprises one or more training prompt and target modified prompt pairs generated using a first generative machine learning model. As described above, the training prompt can be an example of a user prompt or have similar characteristics to user prompts that are typically provided to text-to-vision generation systems. The training prompt can include a text description in natural language of objects and entities and more generally, of a scene to be depicted in an image/video. The first generative machine learning model has been used to re-write and expand upon the training prompt to include additional details, producing the target modified prompt as output.

At step 702, the training prompt is processed by a second generative machine learning model to generate an output modified prompt. As described above, the training prompt can be modified to include additional details. The training prompt can be modified to have increased similarity to prompts used to train a text-to-vision generation system. The second generative machine learning model can be provided with instructions on how to modify the training prompt.

As described above, the second generative machine learning model has a lower parameter count than the first generative machine learning model and therefore has lower memory and storage requirements and can have lower latency than the first generative machine learning model.

The first and second generative machine learning models can have any appropriate architecture. For example, the first and second generative machine learning models can be large language model (LLM) based machine learning models or a multi-modal version of an LLM. As described above, in some implementations, the first generative machine learning model can have a Mixture of Experts architecture and the second generative machine learning model can have a dense architecture. The first and second generative machine learning models can comprise a plurality of neural network layers such as attention-based layers and/or Transformer blocks.

At step 703, the second generative machine learning model is updated using a training objective based upon the output modified prompt and the target modified prompt. As described above, the training objective can be based upon knowledge distillation techniques. The training objective can include any appropriate loss function such as a cross-entropy or mean-squared loss.

As described above, updating the second generative machine learning model can be based upon a parameter efficient fine-tuning technique such as a low rank adaptation. In particular, a subset of the parameters of the second generative machine learning model can be updated with other parameters held frozen. The second generative machine learning model can be pre-trained and the method 700 can be considered a fine-tuning of the second generative machine learning model.

The method 700 can be repeated using further training pairs obtained from the training dataset and can involve a plurality of iterations over the training dataset. The method 700 can be repeated until convergence or a fixed number of training steps have been carried out or other stopping criterion has been reached.

As described above, after training, the second generative machine learning model can be deployed for use in re-writing user prompts for a text-to-vision generation system. The second generative machine learning model can be deployed on a user device such as a mobile device, for example.

In some implementations, the method further comprises generating the training dataset. In more detail, generating the training dataset can comprise obtaining one or more user prompts and for each of the one or more prompts, generating, using the first generative machine learning model, one or more modified user prompts to generate one or more candidate training pairs and adding the candidate training pairs to the training dataset.

In some implementations, prior to adding the candidate training pairs to the training dataset, the method can further comprise filtering the candidate pairs based upon determining whether the modified user prompt entails the original user prompt using a natural language understanding technique.

In addition, or alternatively, prior to adding the candidate training pairs to the training dataset, the method can further comprise obtaining human feedback with respect to the generated candidate pairs and filtering the candidate pairs based upon the obtained human feedback.

The training dataset can comprise a first portion of the training data that is generated by the first generative machine learning model that has not been filtered using human feedback.

The training dataset can comprise a second portion of the training data that is generated by the first generative machine learning model that has been filtered using human feedback.

The training dataset can comprise a third portion of the training data that comprises pairs of human generated captions and synthetically generated captions for a plurality of images or videos obtained from a further training dataset for training a text-to-vision generation system. It will be appreciated that the training dataset can comprise any combination of the first, second and third portions and can also include additional categories of data.

In some implementations, each portion of the training dataset is associated with a sampling weight. For example, the second portion can have the largest sampling weight. In addition, or alternatively, the third portion can have the lowest sampling weight. In step 701, a training pair can be obtained from the training dataset by sampling from the training dataset based upon the sampling weight for each portion.

In some implementations, the output of the first generative machine learning model is constrained based upon a finite state transducer. As described above, the finite state transducer can ensure that the first generative machine learning model provides an output that conforms to a particular format and/or provides a specified number of modified prompts per input prompt.

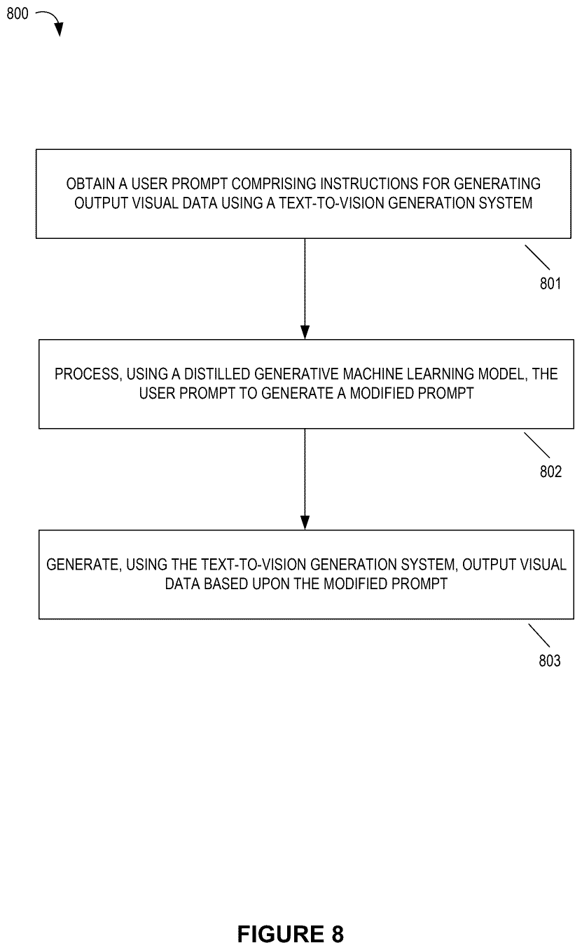

FIG. 8 is a flow diagram illustrating an example method 800 for generating visual data. The processing shown in FIG. 8 can be implemented using the visual data generation system of FIG. 2. As such, features described in the context of FIG. 2 can also be applied to the method of FIG. 8.

At step 801, a user prompt comprising instructions for generating output visual data using a text-to-vision generation system is obtained. The output visual data can comprise an image or video. The user prompt can include a text description in natural language of objects/entities and more generally, of a scene to be depicted in the visual data.

At step 802, the user prompt is processed using a distilled generative machine learning model to generate a modified prompt. The distilled generative machine learning model has been trained using a dataset generated by a reference generative machine learning model having a larger parameter count than the distilled generative machine learning model. For example, the distilled generative machine learning model can be trained using the training process 700 of FIG. 7. In this regard, the distilled generative machine learning model is the trained second generative machine learning model and the reference generative machine learning model is the first generative machine learning model. The distilled generative machine learning model has a lower storage and memory requirement and can have lower latency compared to the reference generative machine learning model.

As described above, the distilled generative machine learning model can modify the user prompt to include additional details. The modified user prompt can provide a better match to the distribution of prompts used to train the text-to-vision generation system. The distilled generative machine learning model can be provided with instructions on how to modify the user prompt.

At step 803, output visual data is generated using the text-to-vision generation system based upon the modified prompt. The generated visual data, e.g., image or video, can depict the objects/entities specified in the user prompt and any additional details contained in the modified prompt.

The text-to-vision generation system can include any appropriate machine learning model capable of generating visual data conditioned on input text. For example, the visual data generation machine learning model can comprise one or more diffusion neural networks (also known as denoising neural networks) such as DDIM (Denoising Diffusion Implicit Models) and DDPM (Denoising Diffusion Probabilistic Models). The text-to-vision generation system can be a multi-modal large language model-based system and can be capable of generating outputs of other modalities such as audio and text and/or is capable of conditioning generation on other modalities such as audio, and on other videos and images.

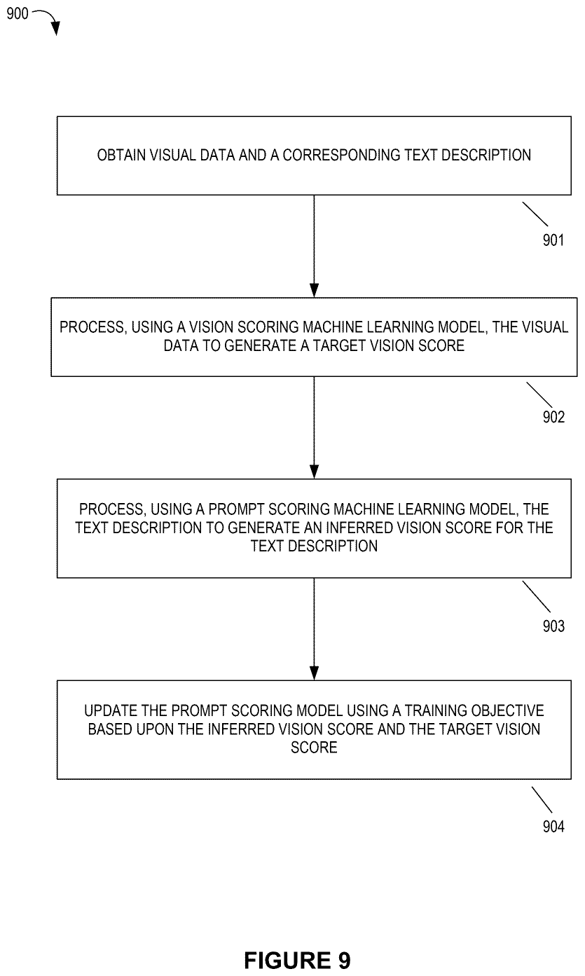

FIG. 9 is a flow diagram illustrating an example method 900 for training a machine learning model to predict vision scores. The processing shown in FIG. 9 can be implemented using the training system of FIG. 3. As such, features described in the context of FIG. 3 can also be applied to the method of FIG. 9.

At step 901, visual data and a corresponding text description are obtained. The visual data and text description can be part of a training dataset of visual data and text description pairs. In some implementations, the text description can be a user prompt that was used to generate the corresponding visual data or the text description can be a re-written user prompt. In other implementations, the text description can be a caption for the visual data which can be a human annotation or generated by an image/video captioning machine learning model.

At step 902, the visual data is processed using a vision scoring machine learning model to generate a target vision score. As described above, the vision scoring machine learning model can be trained based upon image/video scoring data generated from human image/video preference data. The target vision score can provide an indication of a type, quality or other attribute/characteristic of the visual data. In some implementations, the vision scoring machine learning model is trained using a training objective based upon a Bradley-Terry model.

In some implementations, the vision scoring machine learning model comprises a feedforward neural network. In some implementations, the feedforward neural network comprises a single hidden layer.

At step 903, the text description is processed using a prompt scoring machine learning model to generate an inferred vision score for the text description. As described above, the prompt scoring machine learning model can provide a prediction of the vision score from the corresponding text description alone. The inferred vision score produced by a prompt scoring machine learning model can be used as additional conditioning data for generating visual data by a text-to-vision generation system given that an inferred vision score can provide an indication of an expected type, quality or other attribute/characteristic of the visual data to be generated from a user prompt that may not be explicitly specified in the user prompt.

In some implementations, the prompt scoring machine learning model comprises one or more Transformer-based neural network blocks.

In some implementations, the target and inferred vision scores are continuous valued numbers. In some implementations, the vision score is in the range 0 to 10 inclusive. It will be appreciated that vision scores can have any appropriate range deemed suitable by a person skilled in the art. As described above, the target and inferred vision scores can be based upon an image/video ranking.

In some implementations, an embedding of the visual data is generated and the vision scoring machine learning model can process the embedding of the visual data to generate the target vision score. In some implementations, an embedding of the text description can be generated and the prompt scoring machine learning model can process the embedding of the text description to generate the inferred vision score. As described above, both embeddings can be a contrastive embedding. For example, the embeddings can be based upon CLIP or ALIGN.

At step 904, the prompt scoring machine learning model is updated using a training objective based upon the inferred vision score and the target vision score. The prompt scoring machine learning model can be updated using a regression-based training objective. For example, a loss function based upon a mean squared error between the target vision score and inferred vision score can be used.

The method 900 can be repeated using further pairs of visual data and text descriptions and can involve a plurality of iterations over the pairs of a training dataset. The method 900 can be repeated until convergence or a fixed number of training steps have been carried out or other stopping criterion has been reached.

In some implementations, the method can further comprise obtaining a training dataset comprising a plurality of images (and in some implementations, with corresponding text descriptions), clustering the image data and determining candidate pairs of images for generating human preference data by sampling pairs of images within a cluster. In some implementations, clustering the image data can comprise generating an embedding for each image and clustering the image data based upon the embedding of each image. The embedding can be the same type of embedding as described above. As described above, the images shown to human reviewers for ranking can therefore have semantically similar content to provide an easier comparison. It will be appreciated that more than two images can be sampled from each cluster and provided to human reviewers. In some implementations, the training dataset can comprise a plurality of videos and the same embedding/clustering/sampling techniques can be applied.

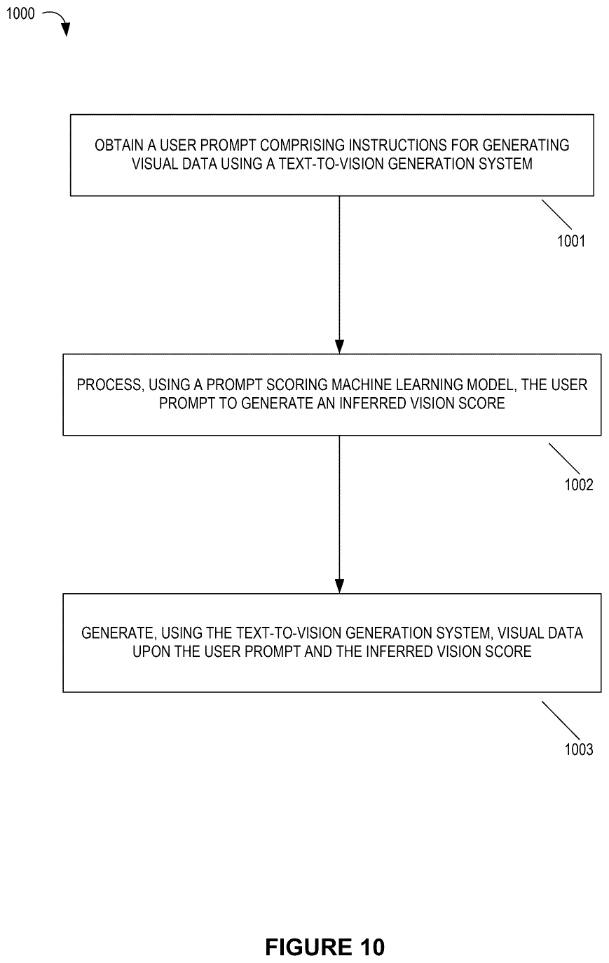

FIG. 10 is a flow diagram illustrating another example method 1000 for generating visual data. The processing shown in FIG. 10 can be implemented using the system of FIG. 4A. As such, features described in the context of FIG. 4A can also be applied to the method of FIG. 10.

At step 1001, a user prompt comprising instructions for generating visual data using a text-to-vision generation system is obtained. As described above, the user prompt can include a text description in natural language of objects/entities and more generally, of a scene to be depicted in the visual data.

At step 1002, the user prompt is processed using a prompt scoring machine learning model to generate an inferred vision score. As discussed above, the inferred vision score can provide an additional signal regarding the visual data that is to be generated that may not be explicitly specified in the user prompt. For example, the inferred vision score could be indicative of a type of or quality of the visual data to be generated or represent another particular attribute or characteristic of the visual data. The prompt scoring machine learning model can be trained using the process of FIG. 9.

At step 1003, visual data is generated using the text-to-vision generation system based upon the user prompt and the inferred vision score. The generated visual data can depict the objects/entities specified in the user prompt and be generated according to the particular attributes and characteristics indicated by the inferred vision score.

In some implementations, a range of vision scores is determined from the inferred vision score and the visual data is generated based upon the range of vision scores. For example, the inferred vision score can be set as a lower bound and the range of vision scores can range from the inferred vision score to the highest possible vision score.

The text-to-vision generation system can include any appropriate machine learning model capable of generating visual data conditioned on input text and additional data such as a vision score. For example, the visual data generation machine learning model can comprise one or more diffusion neural networks (also known as denoising neural networks) such as DDIM (Denoising Diffusion Implicit Models) and DDPM (Denoising Diffusion Probabilistic Models). The text-to-vision generation system can be a multi-modal large language model-based system and can be capable of generating outputs of other modalities such as audio and text as well as visual data and/or is capable of conditioning generation on other modalities such as audio, and on other videos and images.

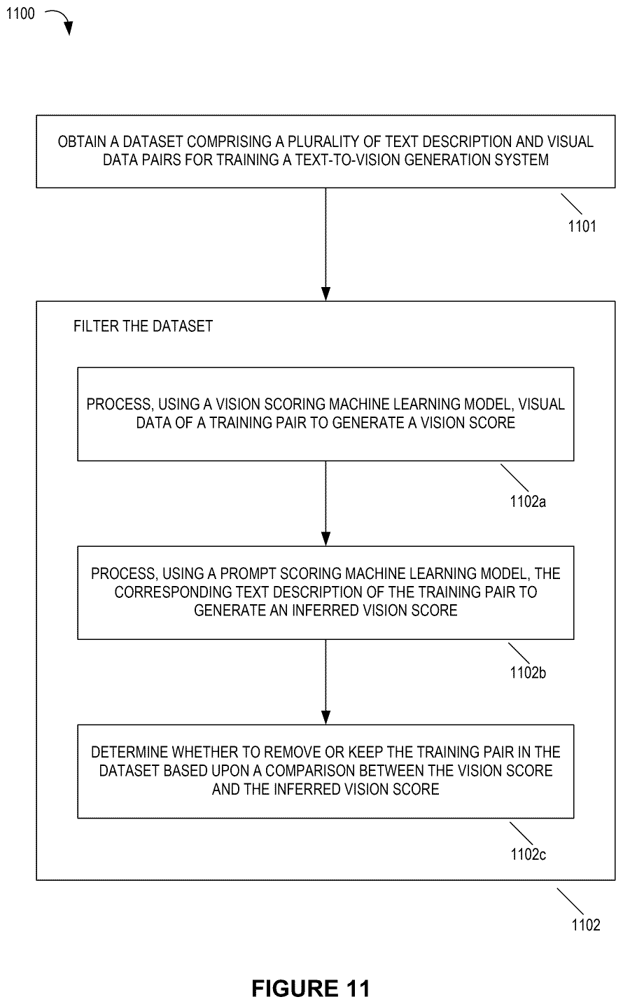

FIG. 11 is a flow diagram illustrating an example method 1100 for filtering a dataset. The processing shown in FIG. 11 can be implemented using the system of FIG. 5A. As such, features described in the context of FIG. 5A can also be applied to the method of FIG. 11.

At step 1101, a dataset is obtained comprising a plurality of text description and visual data training pairs. The dataset can be for training a text-to-vision generation system as described above.

At step 1102, the dataset is filtered. Step 1102 comprises sub-step 1102a in which visual data of a training pair is processed using a vision scoring machine learning model to generate a vision score. The vision scoring machine learning model can be same as that used in process 900 in FIG. 9. As described above, the vision score can be indicative of a type, quality or other attribute/characteristic of the visual data.

At step 1102b, the corresponding text description of the training pair is processed using a prompt scoring machine learning model to generate an inferred vision score. The prompt scoring machine learning model can be trained using the process 900 of FIG. 9 to generate a prediction of the vision score of the corresponding visual data from the text description only.

At step 1103b, it is determined whether to remove or keep the training pair in the dataset based upon a comparison between the vision score and the inferred vision score. For example, as described above, some datasets can comprise visual data obtained from the Internet with text descriptions obtained from corresponding alt-text fields. The alt-text data can however be inaccurate. In such cases, the vision score (generated from the visual data) and the inferred vision score (generated from the text description) may be inconsistent. Visual data and text description pairs that have inconsistent vision and inferred vision scores can be filtered out of the dataset to reduce the noise in the dataset. In some implementations, the visual data and text description pair can be retained when the vision score and inferred vision score are within a pre-determined range of each other. Otherwise, the pair can be removed. In some implementations, the pair can be removed when the vision score and/or inferred vision score are themselves outside of a certain range of values. As described above, the vision and inferred vision scores can be indicative of a type, quality, or other attribute/characteristic of visual data and as such, the vision and inferred vision scores can be used to select for particular ones of those.

Sub-steps 1102a to 1102c can be repeated for further training pairs in the dataset. It will be appreciated that the filtering can result in a separate filtered copy of the dataset that includes the retained training pairs and does not include the training pairs determined for removal, or the original dataset can have the training pairs determined for removal deleted from the dataset, or the training pairs in the original dataset can have associated flags that indicate whether the training pair is to be retained (i.e., usable) or to be deleted (i.e., not usable).

The filtered dataset can subsequently be used to train a text-to-vision generation system. This can be any of the text-to-vision generation systems described herein.

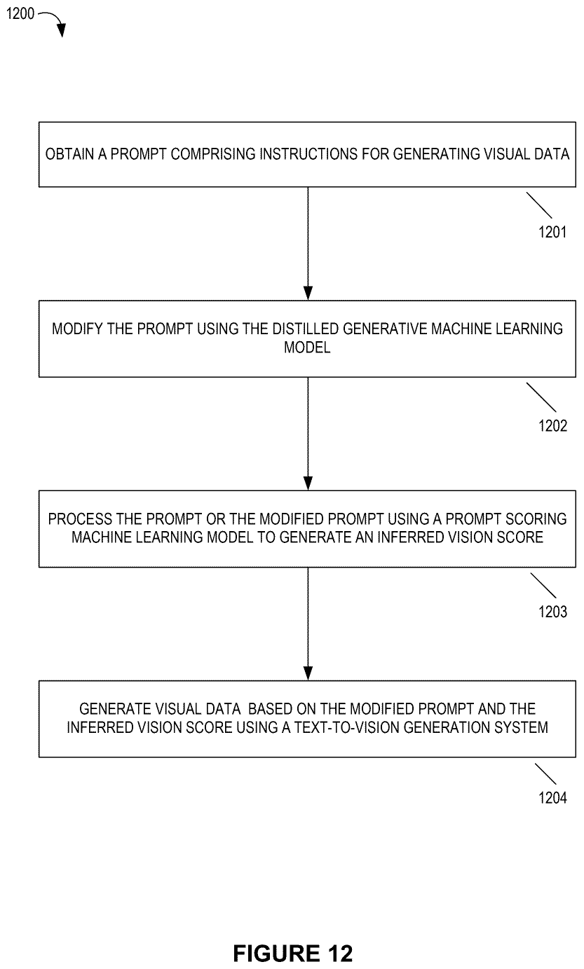

FIG. 12 is a flow diagram illustrating an example method 1200 for generating visual data. The processing shown in FIG. 12 can be implemented using either of the systems of FIGS. 6A and 6B. As such, features described in the context of FIGS. 6A and 6B can also be applied to the method of FIG. 12.

At step 1201, a prompt comprising instructions for generating visual data is obtained. As described above, the user prompt can include a text description in natural language of objects and more generally, of a scene to be depicted in the visual data.

At step 1202, the prompt is modified using a distilled generative machine learning model. This can be carried out in the same way as step 802 of FIG. 8.

At step 1203, the prompt or the modified prompt is processed using a prompt scoring machine learning model to generate an inferred vision score. This can be carried out in the same way as step 1002 of FIG. 10.

At step 1204, visual data is generated based upon the modified prompt and inferred vision score using a text-to-vision generation system. This can be carried out in the same way as step 1003 of FIG. 10 except the modified prompt is used instead of the user prompt.

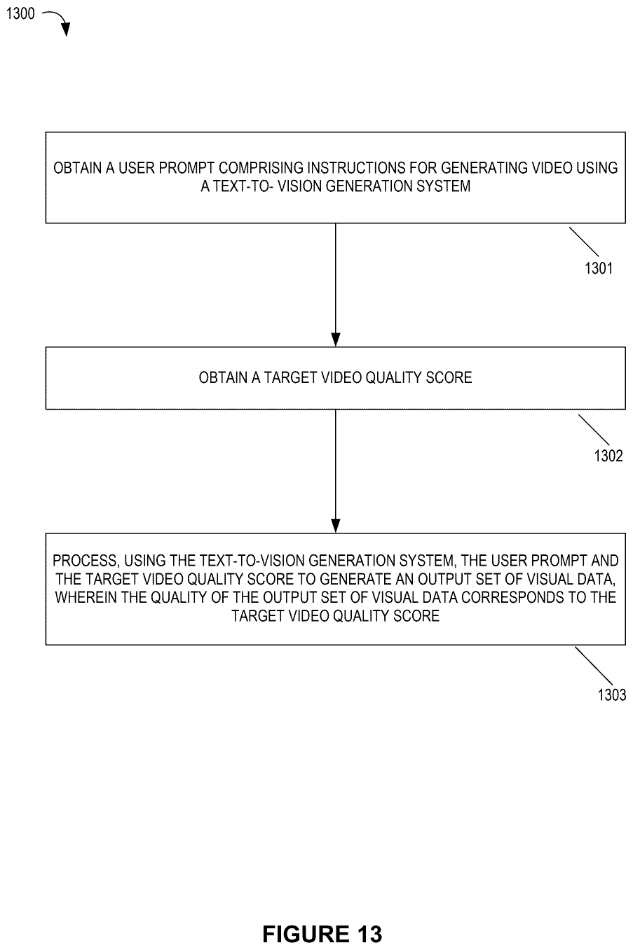

FIG. 13 is a flow diagram illustrating an example method 1300 for generating visual data. The processing shown in FIG. 13 can be implemented using the system of FIG. 4B. As such, features described in the context of FIG. 4B can also be applied to the method of FIG. 13.

At step 1301, a user prompt comprising instructions for generating video using a text-to-vision generation system is obtained. The user prompt can include a text description in natural language of objects, entities and actions that are to occur in the video for example.

At step 1302, a target video quality score is obtained. The target video quality score can be a vision (video) score as described above that is indicative of a target quality of the video that is to be generated. In some implementations, the target video quality score is a numerical value between zero and one. It will be appreciated however that any suitable values can be used as deemed appropriate by a person skilled in the art.

At step 1303, the user prompt and the target video quality score are processed using the text-to-vision generation system to generate an output set of visual data (e.g., video data). The quality of the output set of visual data corresponds to the target video quality score. In some implementations, the text-to-vision generation system 403B comprises a latent diffusion model. Latent diffusion models are described in more detail below.

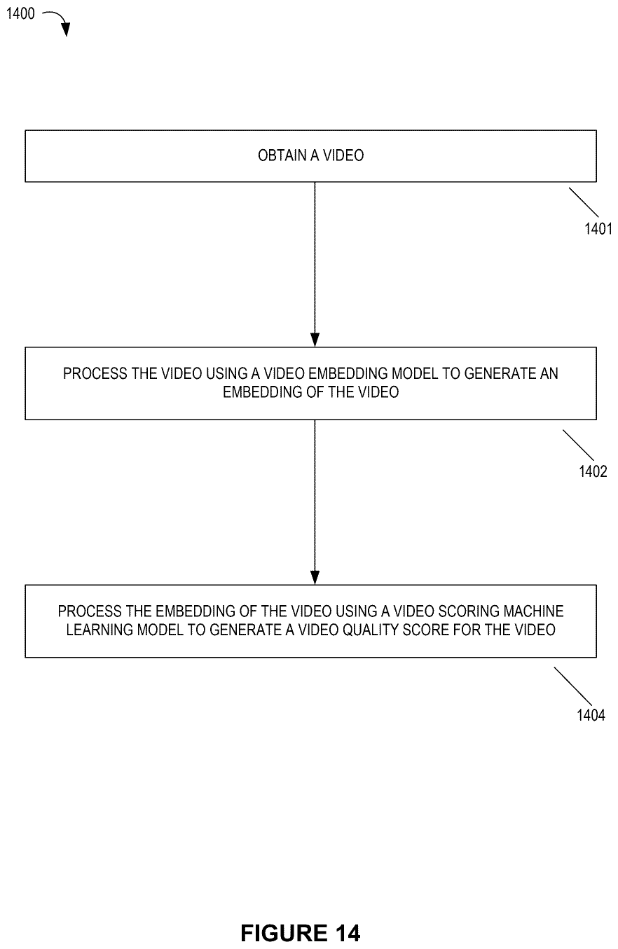

FIG. 14 is a flow diagram illustrating an example method 1400 for generating a video quality score for an input video. The processing shown in FIG. 14 can be implemented using the system of FIG. 5B. As such, features described in the context of FIG. 5B can also be applied to the method of FIG. 14.

At step 1401, a video is obtained. At step 1402, the video is processed using a video embedding model to generate an embedding of the video. In some implementations, the processing comprises generating a subset of frames of the video comprising sampling every N-th frame of video, wherein N>1, and processing the subset of frames of the video using the video embedding model to generate the embedding of the video. In some examples, N corresponds to a predefined framerate, e.g., 1 frame per second. In some examples, N corresponds to a fixed predefined number, e.g., N frames of the video are taken, irrespective of the video length. The embedding model can comprise a contrastive embedding model, such as CLIP or ALIGN as described above. In some examples, processing the subset of frames of the video using a video embedding model to generate an embedding of the video comprises processing each frame of the subset of frames of the video using the video embedding model to generate a respective frame embedding for each frame of the subset of frames. The respective frame embeddings can then be concatenated to generate the embedding of the video.

At step 1403, the embedding of the video is processed using a video scoring machine learning model to generate a video quality score for the video. In some implementations, the video scoring machine learning model comprises a feedforward neural network. In some implementations, the feedforward neural network comprises two hidden layers.

In some implementations, the method can further comprise comparing the video quality score for the video to a threshold video score. In response to determining that the video quality score is above the threshold video score, the video can be included in a training dataset comprising a plurality of videos. Otherwise, the video is not included in the training dataset. The threshold quality score is, in some examples where the score is constrained to be between zero and one, at least 0.5, e.g., at least 0.6, for example. 0.7. The training dataset can be used to train any of the text-to-vision generation systems disclosed herein and in conjunction with any training process disclosed herein or be used to train a video processing machine learning model.

It will be appreciated that whilst the above methods described in FIGS. 7 to 14 follow a particular ordering of steps, such an ordering is not intended to be limiting. For example, some steps can be carried out in a different order or in parallel where there are no specific dependencies between steps. Further details regarding text-to-vision generation systems will now be described. A text-to-vision generation system can use a diffusion model (also referred to as a diffusion neural network or a denoising neural network) to generate visual data such as images or video.

After training a denoising neural network, a system can perform a reverse diffusion process using the denoising neural network to generate a new image or video.

To perform the reverse diffusion process, the system can receive a conditioning input. The conditioning input can include a text description of a target image/video, e.g., desired attributes and/or contents of the generated image/video. In some implementations, the conditioning input further comprises a target quality for the generated image/video. The target quality is, in some examples, provided by the user as part of the input. Alternatively, the target quality can be a default value (e.g., at least 0.5, e.g., 0.7, for a quality score in the range [0, 1]) or a pre-set option. The target quality may be input into the text-to-vision model as an additional one or more tokens appended to the input text description.

The system can then initialize a representation of a new image/video by sampling noise values from a noise distribution.

The system can then update the representation of the new image/video at each of a plurality of reverse diffusion steps.

As part of the updating, at each reverse diffusion step, the system processes a denoising input for the reverse diffusion step that includes the representation of the new image/video using the denoising neural network conditioned on the conditioning input to generate a denoising output that defines an estimate of a noise component of the representation of the new image/video.

Optionally, the system can use classifier-free guidance at each reverse diffusion step. When using classifier-free guidance, the system processes another denoising input for the reverse diffusion step that includes the representation of the new image/video using the denoising neural network but not conditioned on the conditioning input to generate another denoising output. The system then combines the conditional and unconditional denoising outputs in accordance with a guidance weight for the reverse diffusion step to generate a final denoising output.

At each reverse diffusion step, the system then updates the representation of the new image/video using the denoising output.

For example, the system can determine an initial estimate of the final image/video using the denoising output and then apply an appropriate diffusion sampler, e.g., the DDPM (Denoising Diffusion Probabilistic Model) sampler, the DDIM (Denoising Diffusion Implicit Model) sampler or another appropriate sampler, to the initial estimate to update the current representation. At the last reverse diffusion step, the system can use the initial estimate as the updated representation.

After updating the representation of the new image/video at each of the plurality of reverse diffusion steps, the system generates the new image/video from the representation of the new image/video.

As described above, each denoising output defines an estimate of a noise component of the corresponding representation of the corresponding image. The denoising output can define this estimate in any of a variety of ways.

In some implementations, the denoising output is an estimate of the noise component of the current representation, i.e., the noise that needs to be combined with, e.g., added to or subtracted to, a final representation to generate the current representation.

In some other implementations, the denoising output is an estimate of the final representation given the current representation, i.e., an estimate of the representation that would result from removing the noise component of the current representation.

In some other implementations, the denoising output defines a predicted residual between the true noise component of the current representation and an analytic estimate of the noise component, i.e., an estimate that has been computed analytically from the current representation.

In some other implementations, the denoising output is a v-parametrization of the estimate of the noise component.

In any of the above examples, the representations of images/videos received as input by the diffusion neural network (also referred to as a denoising neural network) and updated using the diffusion neural network can either be representations in the output space, i.e., so that the values in the representation are values of image pixels, or an output data item in a latent space, i.e., so that the values in the representation are values in a latent representation of an image in the output space.

When the representations are in a latent space, the system can generate the restored image/video in output space by processing the final representation in the latent space using a decoder neural network, e.g., one that has been pre-trained in an auto-encoder framework with an encoder neural network. During training, the system can use an encoder neural network, e.g., one that has been pre-trained jointly with the decoder in the auto-encoder framework, to encode target images in the output space to generate target representations for the diffusion neural network in the latent space.

The diffusion neural network can be any appropriate diffusion neural network that is configured to receive an input that includes a current (noisy) representation of visual data and a conditioning input and to generate a denoising output.

In some implementations, the diffusion neural network performs a diffusion process in output space, e.g., pixel space when the data items are images/videos. In this example, when the data items are images/videos, the data items (“representations”) operated on and generated by the diffusion neural network have values for each pixel that specify color values, e.g., RGB values or another color encoding scheme.

Examples of such diffusion neural networks include Imagen, further details of which can be found in S. Chitwan, et al. “Photorealistic text-to-image diffusion models with deep language understanding,” Advances in neural information processing systems 35 (2022): 36479-36494 which is hereby incorporated by reference in its entirety.

In some other implementations, the diffusion neural network performs a diffusion process in latent space, e.g., in a latent space that is lower-dimensional than the output space. That is, the data items (“representations”) operated on by the diffusion neural network are latent representations and the values in the representations are learned, latent values, e.g., rather than color values when the data items are images.

An example of a latent diffusion model can also be found in R. Rombach, et al., “High-Resolution Image Synthesis with Latent Diffusion Models,” arXiv: 2112.10752 (2021), which is hereby incorporated by reference in its entirety.

In these implementations, during training, the diffusion neural network can be associated with an encoder to encode training data items into the latent space and, after training and to generate new output data items, a decoder neural network that receives an input that includes a latent representation of a data item and decodes the latent representation to reconstruct the data item.

The generative machine learning models described above can be implemented using LLM-based models. Examples of architectures for LLMs or “language model neural networks” now follow.

For example, an LLM can be an auto-regressive generative neural network that generates each token in the output sequence conditioned on the preceding tokens in the output sequence and at least some of the tokens in the input sequence.

For example, the LLM can be configured to process an input sequence of tokens from a vocabulary of tokens to generate an output sequence of tokens from the vocabulary.

More generally, the language model neural network can be any appropriate neural network that receives an input sequence made up of tokens selected from a vocabulary and auto-regressively generates an output sequence made up of tokens from the vocabulary. For example, the language model neural network can be a Transformer-based language model neural network or a recurrent neural network-based language model neural network.

In some situations, the language model neural network can be referred to as an auto-regressive neural network when the neural network used to implement the language model auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the language model neural network can process the current input sequence to generate a score distribution (e.g., a probability distribution) that assigns a respective score, e.g., a respective probability, to each token in the vocabulary of tokens. The language model neural network can then select, as the particular token, a token from the vocabulary using the score distribution. For example, the neural network of the language model can greedily select the highest-scoring token or can sample, e.g., using nucleus sampling or another sampling technique, a token from the distribution.

As a particular example, the language model neural network can be an auto-regressive Transformer-based neural network that includes (i) a plurality of attention blocks, at least some of which apply a self-attention operation and (ii) an output subnetwork that processes an output of the last attention block to generate the score distribution.

The language model neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al., Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al., Language models are few-shot learners, arXiv preprint arXiv: 2005.14165, 2020.

Training of generative machine learning models will now be described. A generative machine learning model can undergo a first phase of pre-training followed by a second phase of fine-tuning. In general, a generative machine learning model such as an LLM can be pre-trained on large amounts of data including data from, but not limited to, webpages, electronic books, software code, electronic news articles, and machine translation data. The generative machine learning model can be pre-trained using unsupervised or self-supervised learning. For example, the generative machine learning model can be pre-trained on a next token prediction task and/or a masked token prediction task. Pre-training on large quantities of diverse data can provide the generative machine learning model with remarkable natural language reasoning capabilities.

Following pre-training, the generative machine learning model can undergo fine-tuning to improve the model's ability to respond to user prompts and queries. Two example types of fine-tuning techniques are supervised fine-tuning (SFT) and reinforcement learning with human feedback (RLHF).

In SFT, a high-quality dataset including examples of input prompts and corresponding responses can be used. This data is typically generated by human annotators. The generative machine learning model can be trained using supervised learning to generate the corresponding responses from the input prompt. SFT requires a much smaller amount of data that used in pre-training.

In RLHF, a reward model can be trained from human preference data regarding different outputs generated from the same input prompt. That is, given an input prompt, different outputs are generated using different models. The models can be a copy of the generative machine learning model with different parameters obtained through checkpointing during pre-training or the models could be entirely unrelated. The input prompt and the different outputs are shown to human assessors and the human assessors are asked to rank the outputs in order of preference with respect to the input prompt. This can be repeated with many different input prompts to generate a dataset of preference data. A reward model can be trained on this preference data to provide a scalar preference value (a “reward” value) for a particular input prompt and generated output pair. The reward model can be based on the generative machine learning model with an additional head for generating the scalar value for example.

The generative machine learning model undergoing training can then be fine-tuned using reinforcement learning based upon the reward values provided by the trained reward model. That is, for a given training prompt, the generative machine learning model generates an output which can be evaluated using the reward model. The parameters of the generative machine learning model can be adjusted using a reinforcement learning update rule based upon the reward value provided by the reward model. In some implementations, a reinforcement learning update rule based upon the Proximal Policy Optimization (PPO) algorithm is used with the generative machine learning model acting as the “policy”.

Through such training, it is possible that a generative machine learning model can respond to user queries and instructions in a zero-shot manner, for example, by including appropriate instructions and examples in the prompt provided to the generative machine learning model without the need for further extensive fine-tuning. For example, an LLM-based generative machine learning model can be prompted to caption an input image or other data item.

It will be appreciated that the above is not limited to processing text tokens only. In some implementations, an LLM can process and generate tokens of other modalities including image tokens, audio tokens and video tokens. These models are sometimes also referred to as Visual Language Models (VLMs) or multi-modal language models or some variation of such terms. An example of these multi-modal models includes the Gemini family of models, further details of which can be found in Google Gemini Team, “Gemini: a family of highly capable multimodal models,” arXiv preprint arXiv: 2312.11805 (2023) which is hereby incorporated by reference in its entirety. A further example is PaliGemma 2, further details of which can be found in Steiner, Andreas, et al., “PaliGemma 2: A Family of Versatile VLMs for Transfer,” arXiv preprint arXiv: 2412.03555 (2024) which is hereby incorporated by reference in its entirety.

It will be appreciated that the above also applies for any autoregressive neural network that is used in the data generation process. An example of an autoregressive neural network for audio generation is AudioLM, further details of which can found in Z. Borsos, et al., “Audiolm: a language modeling approach to audio generation,” IEEE/ACM transactions on audio, speech, and language processing 31 (2023): 2523-2533 which is hereby incorporated by reference in its entirety.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

As used herein, the term data processing apparatus includes any suitable computing device or hardware for use in performing the methods described in this specification. The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The essential elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

This specification also provides the subject-matter of the following clauses:
Clause 1. A method performed by one or more data processing apparatus, the method comprising:
   obtaining a training prompt and a corresponding target modified prompt from a training dataset, wherein the training dataset comprises one or more training prompt and target modified prompt pairs generated using a first generative machine learning model;
   processing, by a second generative machine learning model, the training prompt to generate an output modified prompt, wherein the second generative machine learning model has a lower parameter count than the first generative machine learning model; and
   updating the second generative machine learning model using a training objective based upon the output modified prompt and the target modified prompt.
Clause 2. The method of clause 1, wherein the method further comprises generating the training dataset, wherein generating the training dataset comprises:
   obtaining one or more user prompts;
   for each of the one or more user prompts:
      generating, using the first generative machine learning model, one or more modified user prompts to generate one or more candidate training pairs; and
      adding the candidate training pairs to the training dataset.
Clause 3. The method of clause 2, wherein the method further comprises:
   prior to adding the candidate training pairs to the training dataset:
      filtering the candidate pairs based upon determining whether the modified user prompt entails the original user prompt using a natural language understanding technique.
Clause 4. The method of clause 2 or 3, wherein the method further comprises:
   prior to adding the candidate training pairs to the training dataset:
      obtaining human feedback with respect to the generated candidate pairs; and
      filtering the candidate pairs based upon the obtained human feedback.
Clause 5. The method of any preceding clause, wherein the training dataset comprises:
   a first portion of the training data that is generated by the first generative machine learning model that has not been filtered using human feedback;
   a second portion of the training data that is generated by the first generative machine learning model that has been filtered using human feedback; and
   a third portion of the training data that comprises pairs of human generated captions and synthetically generated captions for a plurality of images obtained from a further training dataset for training a text-to-image generation system.
Clause 6. The method of clause 5, wherein each portion of the training dataset is associated with a sampling weight;
   wherein the second portion has the largest sampling weight;
   wherein the third portion has the lowest sampling weight;
   wherein obtaining the training prompt and corresponding target modified prompt from the training dataset comprises:
      sampling a training pair from the training dataset based upon the sampling weight for each portion.
Clause 7. The method of any preceding clause, wherein the output of the first generative machine learning model is constrained based upon a finite state transducer.
Clause 8. The method of any preceding clause, wherein the training prompt is modified to have increased similarity to prompts used to train a text-to-image generation system.
Clause 9. The method of any preceding clause, wherein the first generative machine learning model and the second generative machine learning model are large language model (LLM) based machine learning models.
Clause 10. The method of any preceding clause, wherein the second machine learning model is pre-trained.
Clause 11. The method of clause 10, wherein updating the second generative machine learning model is based upon a parameter efficient fine-tuning technique.
Clause 12. The method of clause 11, wherein the parameter efficient fine-tuning technique is based upon a low rank adaptation technique.
Clause 13. A method performed by one or more data processing apparatus, the method comprising:
   obtaining a user prompt comprising instructions for generating output data comprising an image or video using a text-to-image generation system;
   processing, using a distilled generative machine learning model, the user prompt to generate a modified prompt;
   wherein the distilled generative machine learning model has been trained using a dataset generated by a reference generative machine learning model having a larger parameter count than the distilled generative machine learning model; and
   generating, using the text-to-image generation system, the output data based upon the modified prompt.
Clause 14. The method of clause 13, wherein the distilled generative machine learning model is trained according to the method of any one of clauses 1 to 12, and wherein the second generative machine learning model is the distilled generative machine learning model.
Clause 15. A method performed by one or more data processing apparatus, the method comprising:
   obtaining visual data and a corresponding text description, wherein the visual data comprises an image or a video;
   processing, using a vision scoring machine learning model, the visual data to generate a target vision score;
   processing, using a prompt scoring machine learning model, the text description to generate an inferred vision score for the text description; and
   updating the prompt scoring model using a training objective based upon the inferred vision score and the target vision score.
Clause 16. The method of clause 15, wherein the target and inferred vision scores are based upon an image ranking or a video ranking.
Clause 17. The method of clause 15 or 16, wherein the vision scoring machine learning model is trained based upon vision scoring data generated from human image preference data and/or human video preference data.
Clause 18. The method of any one of clauses 15 to 17, wherein the method further comprises:
   obtaining a training dataset comprising a plurality of visual data and text description pairs;
   clustering the visual data;
   determining candidate pairs of visual data for generating human preference data by sampling pairs of visual data within a cluster.
Clause 19. The method of clause 18, wherein clustering the visual data comprises:
   generating an embedding for each set of visual data; and
   clustering the visual data based upon the embeddings of each set of visual data.
Clause 20. The method of clause 19, wherein the embedding of each set of visual data is based upon a contrastive embedding technique.
Clause 21. The method of any one of clauses 15 to 20, wherein the vision scoring machine learning model comprises a feedforward neural network.
Clause 22. The method of clause 21, wherein the feedforward neural network comprises a single hidden layer.
Clause 23. The method of any one of clauses 15 to 22, wherein the prompt scoring machine learning model comprises one or more Transformer-based neural network blocks.
Clause 24. The method of any one of clauses 15 to 23, wherein the vision scoring machine learning model is trained using a training objective based upon a Bradley-Terry model.
Clause 25. The method of any one of clauses 15 to 24, wherein the prompt scoring machine learning model is updated using a regression-based training objective.
Clause 26. The method of any one of clauses 15 to 25, wherein processing, using the vision scoring machine learning model, the visual data to generate the target vision score comprises:
   generating an embedding of the visual data; and
   processing the embedding of the visual data using the scoring machine learning model to generate the target vision score.
Clause 27. The method of clause 26, wherein the visual data is a video, and wherein generating the embedding of the visual data comprises:
   generating a subset of frames of the video, comprising sampling every N-th frame of video, wherein N>1;
   processing the subset of frames of the video using an embedding model to generate the embedding of the visual data.
Clause 28. The method of clause 27, wherein the embedding model comprises a contrastive embedding model.
Clause 29. The method of any one of clauses 15 to 28, wherein processing, using the prompt scoring machine learning model, the text description to generate the inferred vision score comprises:
   generating an embedding of the text description; and
   processing the embedding of the text description using the prompt scoring machine learning model to generate the inferred vision score.
Clause 30. A method performed by one or more data processing apparatus, the method comprising:
   obtaining a user prompt comprising instructions for generating visual data using a text-to-vision generation system;
   processing, using a prompt scoring machine learning model, the user prompt to generate an inferred vision score; and
   generating, using the text-to-vision generation system, a set of visual data based upon the user prompt and the inferred vision score.
Clause 31. The method of clause 30, wherein the prompt scoring machine learning model is trained using a method according to any one of clauses 15 to 29.
Clause 32. A method performed by one or more data processing apparatus, the method comprising:
   obtaining a dataset comprising a plurality of text description and visual data training pairs for training a text-to-vision generation system, wherein the visual data comprises an image or a video; and
   filtering the dataset, wherein filtering the dataset comprises:
      processing, using a scoring machine learning model, visual data of a training pair to generate an vision score;
      processing, using a prompt scoring machine learning model, the corresponding text description of the training pair to generate an inferred vision score; and
      determining whether to remove or keep the training pair in the dataset based upon a comparison between the vision score and the inferred vision score.
Clause 33. The method of clause 32, the method further comprising:
   training a text-to-vision generation system using the filtered dataset.
Clause 34. The method of clause 32 or 33, wherein the prompt scoring machine learning model and/or the vision scoring machine learning model are trained using a method according to any one of clauses 15 to 29.
Clause 34. A method performed by one or more data processing apparatus, the method comprising:
   receiving a prompt comprising instructions for generating a set of visual data;
   modifying the prompt using the distilled generative machine learning model of clause 13 or 14; and
   generating a set of visual data based on the modified prompt using a text-to-vision generation system trained using a training dataset filtered according to the method of any one of clauses 32 to 34.
Clause 36. A method performed by one or more data processing apparatus, the method comprising:
   receiving a prompt comprising instructions for generating a set of visual data;
   modifying the prompt using the distilled generative machine learning model of clause 13 or 14;
   processing the prompt or the modified prompt using the prompt scoring machine learning model of any one of clauses 15 to 31 to generate an inferred vision score; and
   generating an image based on the modified prompt and the inferred vision score using a text-to-vision generation system.
Clause 37. A method performed by one or more data processing apparatus, the method comprising:
   obtaining a user prompt comprising instructions for generating video using a text-to-vision generation system;
   obtaining a target vision quality score; and
   processing, using the text-to-vision generation system, the user prompt and the target vision quality score to generate an output set of visual data, wherein the quality of the output set of visual data corresponds to the target video quality score.
Clause 38. The method of clause 37, wherein the target vision quality score is a numerical value between zero and one.
Clause 39. The method of any of clauses 37 or 38, wherein the text-to-vision generation system comprises a latent diffusion model.
Clause 40. A method performed by one or more data processing apparatus, the method comprising:
   obtaining a video;
   processing the video using a video embedding model to generate an embedding of the video;
   processing the embedding of the video using a video scoring machine learning model to generate a video quality score for the video.
Clause 41. The method of clause 40, wherein processing the video using a video embedding model to generate an embedding of the video comprises:
   generating a subset of frames of the video, comprising sampling every N-th frame of video, wherein N>1; and
   processing the subset of frames of the video using a video embedding model to generate an embedding of the video.
Clause 42. The method of any of clauses 40 or 41, wherein the video embedding model is a contrastive embedding model.
Clause 43. The method of any of clauses 40 to 42, wherein the, wherein the video scoring machine learning model comprises a feedforward neural network.
Clause 44. The method of clause 43, wherein the feedforward neural network comprises two hidden layers.
Clause 45. The method of any of clauses 40 to 44, wherein the method further comprises:
   comparing the video quality score for the video to a threshold video score;
   in response to determining that the video quality score is above the a threshold video score, including the video in a training dataset comprising a plurality of videos; and
   in response to determining that the video quality score is not above the a threshold video score, refraining from including the video in the training dataset.
Clause 46. A system comprising:
   one or more data processing apparatus; and
   a memory storing instructions that when executed by the one or more data processing apparatus cause the one or more data processing apparatus to carry out a method according to any preceding clause.
Clause 47. A non-transitory computer-readable storage medium comprising instructions that when executed by one or more data processing apparatus cause the one or more data processing apparatus to carry out a method according to any one of clauses 1 to 34.
Clause 48. A method performed by one or more data processing apparatus, the method comprising:
   obtaining a user prompt comprising instructions for generating an image using a text-to-image generation system;
   processing, using a distilled generative machine learning model, the user prompt to generate a modified prompt;
   wherein the distilled generative machine learning model has been trained using a dataset generated by a reference generative machine learning model having a larger parameter count than the distilled generative machine learning model; and
   generating, using the text-to-image generation system, an image based upon the modified prompt.
Clause 49. The method of clause 48, wherein the distilled generative machine learning model is trained according to the method of any one of clauses 1 to 12, and wherein the second generative machine learning model is the distilled generative machine learning model.
Clause 50. A method performed by one or more data processing apparatus, the method comprising:
   obtaining an image and a corresponding text description;
   processing, using an image scoring machine learning model, the image to generate a target image score;
   processing, using a prompt scoring machine learning model, the text description to generate an inferred image score for the text description; and
   updating the prompt scoring model using a training objective based upon the inferred image score and the target image score.
Clause 51. The method of clause 50, wherein the target and inferred image scores are based upon an image ranking.
Clause 52. The method of clause 50 or 51, wherein the image scoring machine learning model is trained based upon image scoring data generated from human image preference data.
Clause 53. The method of any one of clauses 50 to 52, wherein the method further comprises:
   obtaining a training dataset comprising a plurality of image and text description pairs;
   clustering the image data;
   determining candidate pairs of images for generating human preference data by sampling pairs of images within a cluster.
Clause 54. The method of clause 53, wherein clustering the image data comprises: generating an embedding for each image; and clustering the image data based upon the embeddings of each image.
Clause 55. The method of clause 54, wherein the embedding of the image is based upon a contrastive embedding technique.
Clause 56. The method of any one of clauses 50 to 55, wherein the image scoring machine learning model comprises a feedforward neural network.
Clause 57. The method of clause 56, wherein the feedforward neural network comprises a single hidden layer.
Clause 58. The method of any one of clauses 50 to 57, wherein the prompt scoring machine learning model comprises one or more Transformer-based neural network blocks.
Clause 59. The method of any one of clauses 50 to 58, wherein the image scoring machine learning model is trained using a training objective based upon a Bradley-Terry model.
Clause 60. The method of any one of clauses 50 to 59, wherein the prompt scoring machine learning model is updated using a regression-based training objective.
Clause 61. The method of any one of clauses 50 to 60, wherein processing, using an image scoring machine learning model, the image to generate a target image score comprises:
   generating an embedding of the image; and
   processing the embedding of the image using the image scoring machine learning model to generate the target image score.
Clause 62. The method of any one of clauses 50 to 61, wherein processing, using a text to image scoring machine learning model, the text description to generate an inferred image score comprises:
   generating an embedding of the text description; and
   processing the embedding of the text description using the prompt scoring machine learning model to generate the inferred image score.
Clause 63. A method performed by one or more data processing apparatus, the method comprising:
   obtaining a user prompt comprising instructions for generating an image using a text-to-image generation system;
   processing, using a prompt scoring machine learning model, the user prompt to generate an inferred image score; and
   generating, using the text-to-image generation system, an image based upon the user prompt and the inferred image score.
Clause 64. The method of clause 63, wherein the prompt scoring machine learning model is trained using a method according to any one of clauses 50 to 62.
Clause 65. A method performed by one or more data processing apparatus, the method comprising:
   obtaining a dataset comprising a plurality of text description and image training pairs for training a text-to-image generation system; and
   filtering the dataset, wherein filtering the dataset comprises:
      processing, using an image scoring machine learning model, an image of a training pair to generate an image score;
      processing, using a prompt scoring machine learning model, the corresponding text description of the training pair to generate an inferred image score; and
      determining whether to remove or keep the training pair in the dataset based upon a comparison between the image score and the inferred image score.
Clause 66. The method of clause 65, the method further comprising:
   training a text-to-image generation system using the filtered dataset.
Clause 67. The method of clause 65 or 66, wherein the prompt scoring machine learning model and/or the image scoring machine learning model are trained using a method according to any one of clauses 50 to 62.
Clause 68. A method performed by one or more data processing apparatus, the method comprising:
   receiving a prompt comprising instructions for generating an image;
   modifying the prompt using the distilled generative machine learning model of clause 48 or 49; and
   generating an image based on the modified prompt using a text-to-image generation system trained using a training dataset filtered according to the method of any one of clauses 65 to 67.
Clause 69. A method performed by one or more data processing apparatus, the method comprising:
   receiving a prompt comprising instructions for generating an image;
   modifying the prompt using the distilled generative machine learning model of clause 48 or 49;
   processing the prompt or the modified prompt using the prompt scoring machine learning model of any one of clauses 50 to 64 to generate an inferred image score; and
   generating an image based on the modified prompt and the inferred image score using a text-to-image generation system.
Clause 70. A system comprising:
   one or more data processing apparatus; and
   a memory storing instructions that when executed by the one or more data processing apparatus cause the one or more data processing apparatus to carry out a method according to any one of clauses 1 to 12 or 48 to 69.
Clause 71. A non-transitory computer-readable storage medium comprising instructions that when executed by one or more data processing apparatus cause the one or more data processing apparatus to carry out a method according to any one of clauses 1 to 12 or 48 to 69.

Particular embodiments of the subject matter have been described. Other embodiments are within the scope of the following claims. For example, the actions recited in the claims can be performed in a different order and still achieve desirable results. In some cases, multitasking and parallel processing may be advantageous.

What is claimed is:

1. A method performed by one or more data processing apparatus, the method comprising:
obtaining a training prompt and a corresponding target modified prompt from a training dataset, wherein the training dataset comprises one or more training prompt and target modified prompt pairs generated using a first generative machine learning model;
processing, by a second generative machine learning model, the training prompt to generate an output modified prompt, wherein the second generative machine learning model has a lower parameter count than the first generative machine learning model; and
updating the second generative machine learning model using a training objective based upon the output modified prompt and the target modified prompt.

2. The method of claim 1, wherein the method further comprises generating the training dataset, wherein generating the training dataset comprises:
obtaining one or more user prompts;
for each of the one or more user prompts:
generating, using the first generative machine learning model, one or more modified user prompts to generate one or more candidate training pairs; and
adding the candidate training pairs to the training dataset.

3. The method of claim 2, wherein the method further comprises:
prior to adding the candidate training pairs to the training dataset:
filtering the candidate pairs based upon determining whether the modified user prompt entails the original user prompt using a natural language understanding technique.

4. The method of claim 2, wherein the method further comprises:
prior to adding the candidate training pairs to the training dataset:
obtaining human feedback with respect to the generated candidate pairs; and
filtering the candidate pairs based upon the obtained human feedback.

5. The method of claim 1, wherein the training dataset comprises:
a first portion of the training data that is generated by the first generative machine learning model that has not been filtered using human feedback;
a second portion of the training data that is generated by the first generative machine learning model that has been filtered using human feedback; and
a third portion of the training data that comprises pairs of human generated captions and synthetically generated captions for a plurality of images obtained from a further training dataset for training a text-to-vision generation system.

6. The method of claim 5, wherein each portion of the training dataset is associated with a sampling weight;
wherein the second portion has the largest sampling weight;
wherein the third portion has the lowest sampling weight;
wherein obtaining the training prompt and corresponding target modified prompt from the training dataset comprises:
sampling a training pair from the training dataset based upon the sampling weight for each portion.

7. The method of claim 1, wherein the output of the first generative machine learning model is constrained based upon a finite state transducer.

8. The method of claim 1, wherein the training prompt is modified to have increased similarity to prompts used to train a text-to-vision generation system.

9. The method of claim 1, wherein the first generative machine learning model and the second generative machine learning model are large language model (LLM) based machine learning models.

10. The method of claim 1, wherein the second machine learning model is pre-trained.

11. The method of claim 10, wherein updating the second generative machine learning model is based upon a parameter efficient fine-tuning technique.

12. The method of claim 11, wherein the parameter efficient fine-tuning technique is based upon a low rank adaptation technique.

13. A method performed by one or more data processing apparatus, the method comprising:
obtaining a user prompt comprising instructions for generating output data comprising an image or video using a text-to-vision generation system;
processing, using a distilled generative machine learning model, the user prompt to generate a modified prompt;
wherein the distilled generative machine learning model has been trained using a dataset generated by a reference generative machine learning model having a larger parameter count than the distilled generative machine learning model; and
generating, using the text-to-vision generation system, the output data based upon the modified prompt.

14. The method of claim 13, wherein the distilled generative machine learning model has been trained according to a training method comprising:
obtaining a training prompt and a corresponding target modified prompt from a training dataset, wherein the training dataset comprises one or more training prompt and target modified prompt pairs generated using the reference generative machine learning model;
processing, by the distilled generative machine learning model, the training prompt to generate an output modified prompt; and
updating the distilled generative machine learning model using a training objective based upon the output modified prompt and the target modified prompt.

15. The method of claim 14, wherein the training method further comprises generating the training dataset, wherein generating the training dataset comprises:
obtaining one or more training user prompts;
for each of the one or more training user prompts:
generating, using the reference generative machine learning model, one or more modified user prompts to generate one or more candidate training pairs; and
adding the candidate training pairs to the training dataset.

16. The method of claim 14, wherein the training method further comprises:
prior to adding the candidate training pairs to the training dataset:
filtering the candidate pairs based upon determining whether the modified user prompt entails the original training user prompt using a natural language understanding technique.

17. The method of claim 14, wherein the training method further comprises:
prior to adding the candidate training pairs to the training dataset:
obtaining human feedback with respect to the generated candidate pairs; and
filtering the candidate pairs based upon the obtained human feedback.

18. The method of claim 14, wherein the training dataset comprises:
a first portion of the training data that is generated by the reference generative machine learning model that has not been filtered using human feedback;
a second portion of the training data that is generated by the reference generative machine learning model that has been filtered using human feedback; and
a third portion of the training data that comprises pairs of human generated captions and synthetically generated captions for a plurality of images obtained from a further training dataset for training a text-to-vision generation system.

19. The method of claim 18, wherein each portion of the training dataset is associated with a sampling weight;
wherein the second portion has the largest sampling weight;
wherein the third portion has the lowest sampling weight;
wherein obtaining the training prompt and corresponding target modified prompt from the training dataset comprises:
sampling a training pair from the training dataset based upon the sampling weight for each portion.

20. A system comprising:
one or more data processing apparatus; and
one or more non-transitory computer readable storage media storing instructions that when executed by the one or more data processing apparatus causes the one or more data processing apparatus to carry out a method comprising:
obtaining a training prompt and a corresponding target modified prompt from a training dataset, wherein the training dataset comprises one or more training prompt and target modified prompt pairs generated using a first generative machine learning model;
processing, by a second generative machine learning model, the training prompt to generate an output modified prompt, wherein the second generative machine learning model has a lower parameter count than the first generative machine learning model; and
updating the second generative machine learning model using a training objective based upon the output modified prompt and the target modified prompt.
